(19) United States
(12) Patent Application Publication
(10) Pub. No.: US 2025/0125575 A1
(43) Pub. Date: Apr. 17, 2025

(54) LIGHT PULSE GENERATORS USING A PULSE-RECYCLING FILTER

(71) Applicants: TERAXION INC., Quebec (CA); UNIVERSITÉ LAVAL, Quebec (CA); CÉGEP GARNEAU, Quebec (CA)

(72) Inventors: François TRÉPANIER, Quebec (CA); Vincent BOULANGER, Quebec (CA); Michel OLIVIER, Quebec (CA)

(21) Appl. No.: 18/918,360

(22) Filed: Oct. 17, 2024

Related U.S. Application Data
(60) Provisional application No. 63/590,909, filed on Oct. 17, 2023.

(51) Int. Cl. H01S 3/094; H01S 3/067; H01S 3/10

(52) U.S. Cl. CPC H01S 3/094084; H01S 3/0675; H01S 3/10061

(57) ABSTRACT

A light pulse generator is provided, comprising a linear resonator cavity supporting the back-and-forth propagation of cavity light pulses therein. The linear resonator cavity has a linear optical path apt to induce a spectral broadening of the cavity light pulses. The light pulse generator includes first and second cavity-end filters disposed at opposite extremities of the linear optical path, and at least one optical gain region positioned in the linear optical path. A light output is optically coupled to the first cavity-end filter. The light pulse generator also includes a pulse-recycling filter optically coupled to the second cavity-end filter and having a reflectivity profile centered on a third wavelength. The pulse-recycling filter is configured to receive at least a spectral portion of the cavity light pulses and reflect recycled light pulses for a single pass through the at least one optical gain region and for extraction through the light output.

### CROSS REFERENCE TO RELATED APPLICATION

This application claims the benefit of priority under 35 U.S.C. § 119 (e) to U.S. Provisional Patent Application No. 63/590,909, filed Oct. 17, 2023, which is incorporated herein by reference in its entirety.

### TECHNICAL FIELD

The technical field generally relates to ultrafast light pulses generation and more specifically concerns the use of a pulse-recycling filter extra or intra cavity of a laser oscillator.

### BACKGROUND

Ultrafast fiber laser sources are used in a wide variety of applications across life sciences and industrial and scientific areas. Typical examples of these applications are multiphoton and time-resolved microscopy, femtosecond micromachining, generation of higher harmonics, supercontinuum or terahertz waves and two-photon polymerization. These applications typically rely on a stable source of high-energy ultrashort pulses provided by a low-power femtosecond oscillator amplified by a complex system involving several components and free-space propagation.

To improve the energy of the oscillators and reduce the complexity of the amplifying system, an ultrafast laser architecture commonly known as a Mamyshev oscillator (MO) was introduced [M. Piche, Proc. SPIE 2041, 358 (1994); Stéphane Pitois, Christophe Finot, Lionel Provost, and David J. Richardson, “Generation of localized pulses from incoherent wave in optical fiber lines made of concatenated Mamyshev regenerators,” J. Opt. Soc. Am. B 25, 1537-1547 (2008)] and eventually developed to reach unprecedented peak power levels in ytterbium-doped systems emitting at 1060 nm [Z. Liu, Z. M. Ziegler, L. G. Wright, and F. W. Wise, Optica 4, 649 (2017); W. Liu, R. Liao, J. Zhao, J. Cui, Y. Song, C. Wang, and M. Hu, Optica 6, 194 (2019)]. Such high-energy oscillators were also demonstrated in erbium-doped fibers emitting at 1565 nm [M. Olivier, V. Boulanger, F. Guilbert-Savary, P. Sidorenko, F. W. Wise, and M. Piché, Opt. Lett. 44, 851 (2019)] and thulium-doped fibers emitting at 1965 nm [P. Repgen, B. Schuhbauer, M. Hinkelmann, D. Wandt, A. Wienke, U. Morgner, J. Neumann, and D. Kracht, Opt. Express 28, 13837 (2020)], although the energy at those wavelengths is limited by the availability of optical fibers with normal dispersion and low nonlinearity. Early demonstrations of high-energy MO were based on ring cavities involving free-space propagation sections to provide more control and facilitate the exploration of the parameters. Linear cavities with free-space segments were also considered. In order to simplify the design and improve the robustness of Mamyshev oscillators, all polarization-maintaining fiber linear cavities bounded by fiber Bragg gratings were also introduced [V. Boulanger, M. Olivier, F. Guilbert-Savary, F. Trépanier, M. Bernier and M. Piche, Optics Letters 45, 3317 (2020); V. Boulanger, M. Olivier, F. Trépanier, P. Deladurantaye and M. Piché, Optics Letters 48, 2700 (2023)].

Applications requiring very high pulse energy (uJ or more) usually involve Chirped Pulse Amplification (CPA) to avoid detrimental nonlinear effects in the amplifier (see for example the first paper on CPA: D. Strickland and G. Mourou, “Compression of amplified chirped optical pulses”, Opt. Commun. 56, 219 (1985), DOI: 10.1016/0030-4018 (85) 90151-8). Before the main amplifier, the pulse is stretched above 100 picoseconds to achieve sufficient energy for most applications. In a standard configuration, this type of laser system combines a stable low-power femtosecond oscillator for the seed pulse, an external pulse stretcher, at least one pulse picker, several amplifiers, and a pulse compressor at the end. They are complex and involve multiple electrical and optical components. For example, the external pulse stretcher requires the use of an optical circulator which comes with laser power and spectral bandwidth limitations. After compression, the pulse duration is usually limited above 200 femtoseconds due to gain-narrowing in the amplifiers. In accordance, the seed pulse spectral bandwidth must be below 20 nanometers for the CPA. A higher seed pulse energy from the oscillator could mitigate some of the gain-narrowing to achieve a shorter pulse duration while also removing the need for multiple pre-amplification stages.

In Mamyshev oscillators (MO), stable Mode-locking (or pulse generation) is achieved by a periodic nonlinear spectral broadening by self-phase modulation (SPM) allowing resonant feedback between two offset spectral filters. However, some filter overlap is usually required in the initial state for self-start by pump modulation. The nonlinear feedback allows for less loss per roundtrip for the pulsed state while gain saturation prevent CW breakthrough. Dynamical adjustment of the filter offset can also be employed once mode-locking is achieved. The MO usually output pulses with a duration of a few picoseconds (less than about 10 ps) and large spectral bandwidth (greater than about 20 nm) which can be compressed externally below 100 femtoseconds. With those parameters, the pulse energy goes relatively high (greater than about 20 nJ) in comparison to other oscillators. The energy and spectral bandwidth are heavily correlated with the optical fiber parameters such as core size, dispersion, and gain; a higher pulse energy comes with a larger spectrum. The oscillator repetition rate is also correlated due to the intra-cavity fiber length.

It is known in the art that achieving a high energy and single-mode output with less spectral bandwidth and/or longer pulse duration, at any repetition rate, can be challenging, due to the intrinsic dependency of the MO on spectral broadening and high intra-cavity peak power. The spectral shape is also dictated by the nonlinear pulse evolution within the fiber and cannot be made to achieve an arbitrary shape such as a perfect or near-perfect Gaussian. The standard two-filter MO, while very energetic, does not generate pulses which are appropriate for subsequent amplification in a CPA system without additional pulse filtering and stretching. These actions induce many losses which are detrimental to the sought-after high-energy property from the oscillator.

There remains a need in the art for light pulse generators providing at least some improvements over the prior art.

### SUMMARY

In accordance with one aspect, there are provided light pulse generator configurations which make use of a pulse-recycling filter inside or outside of a MO cavity or other types or resonator cavities. The pulse-recycling filter returns chirped recycled light pulses towards at least one intra-cavity amplifier.

In accordance with one aspect, there is provided a light pulse generator for generating output light pulses, comprising:
an optical path supporting the mode-locked resonant propagation of main light pulses;
at least one optical gain region in the optical path;
a pulse-recycling filter optically coupled to the optical path such that the main light pulses are incident thereon, the pulse-recycling filter having a reflectivity profile centered on a recycling wavelength and being configured to reflect a recycled light pulse to the optical path for a single pass through the gain region; and
an output optically coupled to the optical path and configured to extract the output pulses therefrom, said output light pulses containing at least light at said recycled wavelength.

In some implementations, the pulse-recycling filter is a Chirped Fiber Bragg Grating, which enables an all-fiber configuration.

In some implementations, the pulse-recycling filter can have spectral overlap with a cavity-end filter on the same side of a gain medium or gain region to avoid CW oscillation in accordance with the basic working principle of the MO.

One skilled in the art will readily understand that the light pulse generator configurations described herein may be generalized, for example, to multiple pulse-recycling filters to generate multiple chirped output pulses (bursts) at one or multiple outputs with or without fiber couplers.

The pulse-recycling filter returns a fraction of the cavity light pulse spectrum back towards the cavity gain medium. The gain medium is usually a rare-earth (ytterbium, erbium, thulium, neodymium, praseodymium, etc.) doped optical fiber which provides amplification at the desired wavelength. In some implementations, the pulse-recycling filter returns this fraction as a highly chirped pulse output (for example greater than about 50 ps) which is spectrally shaped and re-amplified in the oscillator gain media while avoiding or managing nonlinear effects. This already stretched and high energy pulse (for example greater than about 10 nJ) is then taken as the main output from the light pulse generator and can be further amplified outside the cavity in the typical manner of CPA to achieve the required final energy (for example greater than 1 uJ).

In examples of CPA systems, the spectral response (amplitude and phase) of the pulse-recycling filter can be chosen to match the compressor dispersion and achieve a high-quality transform-limited pulse with an arbitrary spectral shape. The exact output spectral shape and phase will be dictated by the spectral profile of the pulse-recycling filter and its overlap with the cavity pulse spectrum. Additional filtering effects such as gain-narrowing can occur and be corrected for.

Other features and advantages will be better understood upon of reading of detailed embodiments with reference to the appended drawings.

### BRIEF DESCRIPTION OF THE DRAWINGS

FIG. 1A is a schematic representation of a light pulse generator in a linear cavity configuration wherein the pulse-recycling filter is positioned outside of the cavity; FIG. 1B is a schematic representation of a light pulse generator in a linear cavity configuration wherein the pulse-recycling filter is positioned inside of the cavity.

FIGS. 2A and 2B shows the spectral evolution of a Gaussian pulse being broadened by SPM while propagating in a medium.

FIG. 3 is a graph showing examples of reflectivity profiles for the first and second cavity-end filters and for the pulse-recycling filter for the light pulse generator configuration of FIG. 1A.

FIG. 4A schematically illustrates the evolution of the spectral contents of light circulating through the light pulse generator of FIG. 1A; FIG. 4B schematically illustrates the evolution of the spectral contents of light circulating through the light pulse generator of FIG. 1B; and FIG. 4C shows the evolution of the cavity light pulses circulating in the linear cavity of FIG. 1A.

FIG. 5 illustrates a configuration of a light pulse generator according to one variant including an output pulse separator using a spectral-based separation mechanism.

FIG. 6 illustrates a configuration of a light pulse generator according to one variant including an output pulse separator using a time-based separation mechanism.

FIG. 7 illustrates a configuration of a light pulse generator according to one variant including an output pulse separator using a polarization-based separation mechanism.

FIGS. 8 to 10 are schematic representations of variants of light pulse generators in a circular cavity configuration.

FIG. 11 is a schematic representation of a light pulse generator in a linear cavity configuration using a blocking filter to generate the cavity light pulses.

FIG. 12A is a graph of the reflectivity profiles of the cavity-end filters of the light pulse generator of FIG. 11; FIG. 12B is a graph of the reflectivity profiles of the cavity-end filters, blocking filter and pulse-recycling filter of the light pulse generator of FIG. 11.

FIG. 13 is a schematic representation of a light pulse generator in a linear cavity configuration with the pulse-recycling filter coupled to the linear cavity using a circulator.

FIG. 14 is a schematic representation of a light pulse generator in a NALM configuration using a pulse-recycling filter as described herein.

FIG. 15 shows a simulated example of a light pulse generator according to one implementation, for generating output pulses at an output wavelength of 1030 nm and a repetition rate of 50 MHz.

FIG. 16A shows the simulated stretched pulse profile coming from the pulse-recycling filter of FIG. 15; FIG. 16B shows spectrum and spectral phase for the same pulse; FIG. 16C shows the relative phase fluctuations after simulated compression by a grating pair; FIG. 16D shows the associated spectrum in function of frequency; and FIG. 16E shows the resulting gaussian-like pulse profile after compression.

### DETAILED DESCRIPTION

The present description concerns configurations of light pulse generators making use of a pulse recycling filter.

It is to be understood that the phraseology and terminology employed in the present description is not to be construed as limiting and are for descriptive purposes only.

Furthermore, it is to be understood that the technology can be carried out or practiced in various ways and that it can be implemented in embodiments other than the ones outlined described herein.

Meanings of technical and scientific terms used herein are to be commonly understood as by one of ordinary skill in the art to which the invention belongs, unless otherwise defined.

In the following description, similar features in the drawings have been given similar reference numerals. In order not to unduly encumber the figures, some elements may not be indicated on some figures if they were already mentioned in preceding figures. It should also be understood herein that the elements of the drawings are not necessarily drawn to scale and that the emphasis is instead being placed upon clearly illustrating the elements and structures of the present embodiments.

The terms “a”, “an” and “one” are defined herein to mean “at least one”, that is, these terms do not exclude a plural number of items, unless stated otherwise. Terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements may be mechanical, optical, electrical, logical, or any combination thereof. In particular, the expression “optically coupled” as used herein is meant to refer to any means enabling light to propagate between the elements being optically coupled. The optical coupling may be direct or indirect, and additional optical elements may be provided between the elements being optically coupled without departing from the present definition of optical coupling.

In the present description, the terms “light” and “optical”, and variants and derivatives thereof, are used to refer to radiation in any appropriate region of the electromagnetic spectrum. The terms “light” and “optical” are therefore not limited to visible light, but can also include, without being limited to, the infrared or ultraviolet regions of the electromagnetic spectrum. Also, the skilled person will appreciate that the definition of the ultraviolet, visible and infrared ranges in terms of spectral ranges, as well as the dividing lines between them, may vary depending on the technical field or the definitions under consideration, and are not meant to limit the scope of applications of the present techniques.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

In the present description, when a broad range of numerical values is provided, any possible narrower range within the boundaries of the broader range is also contemplated. For example, if a broad range value of from 0 to 1000 is provided, any narrower range between 0 and 1000 is also contemplated. If a broad range value of from 0 to 1 is mentioned, any narrower range between 0 and 1, i.e. with decimal value, is also contemplated.

As known to those skilled in the art, ultrashort light pulses have a duration of the order of a few picoseconds (ps) or less. By convention, the duration of a light pulse is typically measured as the full width at half maximum (FWHM) of the peak representing the intensity or irradiance of the light pulse over time. In some implementations, the duration of the ultrashort light pulses may be less than about 10 picoseconds or less then about 1 picosecond. In one embodiment, the duration of the ultrashort light pulses is between about 1 picosecond and about 5 picoseconds. In some implementations, the duration of the ultrashort light pulses may be in the femtosecond (fs) range. Ultrashort light pulses are also referred to in the art as ultrafast light pulses, even if the later expression could technically be said to refer to the speed at which the light pulses travel, which may vary as a function of the refractive index of the medium in which it travels. One skilled in the art will readily understand that in practice, both expressions may be used interchangeably to refer to light pulses of short duration.

The ultrashort light pulses generated by the light pulse generators described herein may be used in a variety of contexts. Examples of applications of ultrashort light pulses include micromachining (e.g. fuel injectors, battery electrodes cutting), ophthalmology, lab-on-a-chip, semiconductor dicing, stents manufacturing, internal engraving of transparent material, etc. Generally, the ultrashort light pulses outputted by the light pulse generator require amplification prior to their use in typical applications. It is well known to amplify ultrashort light pulses using a chirped pulse amplification system. Chirped Pulse Amplification (CPA) is a widely used technique to amplify light pulses to high energies, while mitigating the deleterious effects of nonlinearities. This is achieved by temporally spreading each pulse before amplification to reduce peak power, followed by post-amplification compression, resulting in a short, high energy pulse train. Other strategies may use a nonlinear amplifier to favor the formation of very short pulses after compression. As examples, the ultrashort light pulses may be amplified using a gain managed systems such as for example described in US20200278498 (WISE) or with a self-similar amplifier scheme [M. Fermann, V. Kruglov, B. Thomsen, J. Dudley and J. Harvey, Physical Review Letters 84, 610 (2000)].

In some embodiments, the light pulse generators described herein are implemented in a Mamyshev oscillator forming a linear resonator cavity bounded by two filters at wavelengths λ₁ and λ₂. One of the outputs of the resonator cavity, for example that associated with the filter at λ₁, is recycled back to the resonator cavity via a reflective element centered on a wavelength λ₃. This recycled part, in the form of a pulse, makes one more trip through the gain region of the cavity and is then extracted from the system through the filter at λ₂. It is thus added to the main pulse of the Mamyshev oscillator for a single trip through the linear cavity.

Preferably, the reflective element returns a signal that will not interfere with the proper operation of the Mamyshev oscillator. This may be accomplished through proper selection of design parameters, including for example the spectral separation between wavelength λ₃ and wavelengths λ₁ and λ₂. The recycled portion is preferably stretched at the temporal level to avoid excessive nonlinear effects in the Mamyshev oscillator, which would broaden the spectrum of the pulse, possibly generating an overlap between the spectrum of the recycled signal and the filters λ₁ and λ₂ and destabilizing the oscillator. The recycled pulse may also be temporally offset with respect to the main pulse of the Mamyshev oscillator to avoid a temporal overlap that could potentially lead to interaction with the main pulse and destabilization of the Mamyshev oscillator. In some implementation the reflective element may advantageously be embodied by Chirped Fiber Bragg grating (CFBG), but other equivalent elements could be considered, such as a loop-fibered mirror including a filter and a dispersive line. In some implementations, the reflective element may be tunable in dispersion and/or amplitude.

It will be readily understood by one skilled in the art that although the embodiments described below are mainly optical fiber based, the light pulse generators described herein may be embodied in configurations where some or all components could be free-propagating components such as chirped mirrors, interference filters, Lyot filters, etc. In these situations, the spectral broadening would not be due to fibers, but rather to a crystal, waveguide or other dispersive, non-linear material element. Such embodiments may be useful in the context of solid-state lasers, semiconductor lasers, etc.

### Components of the Light Pulse Generator

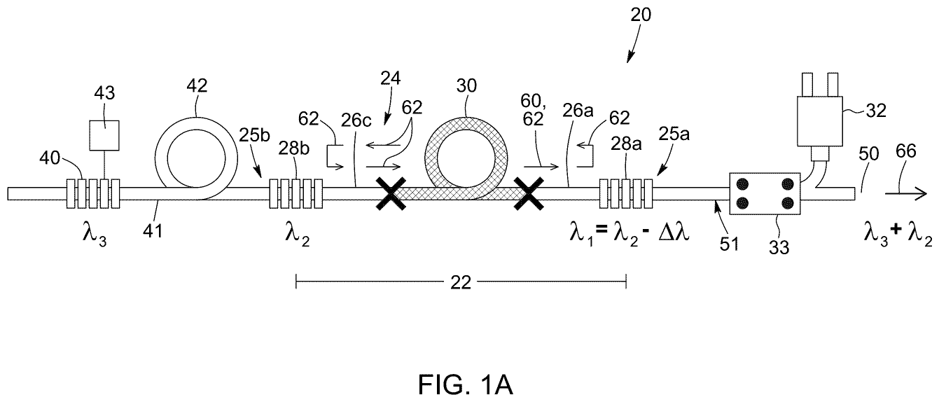

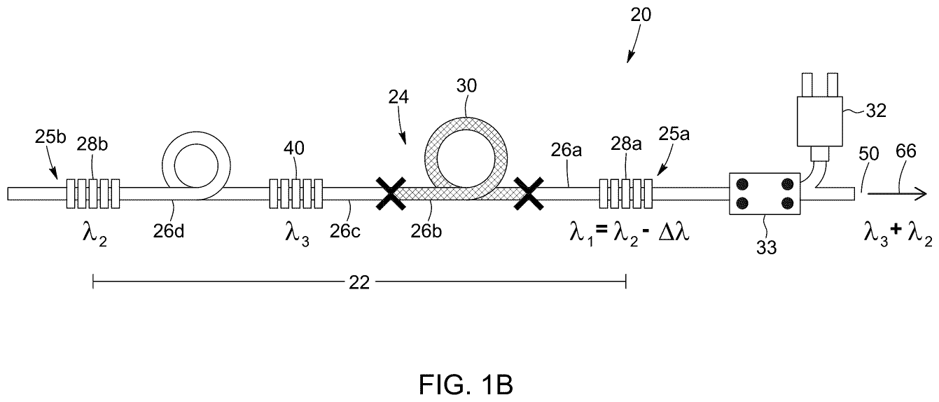

Referring to FIG. 1A, a light pulse generator 20 according to one embodiment is schematically illustrated.

The light pulse generator first includes a linear resonator cavity 22 supporting the back-and-forth propagation of cavity light pulses therein, as described further below. The resonator cavity includes a linear cavity optical path 24 apt to induce a spectral broadening of light propagating therealong. The resonator cavity 22 further includes a pair of cavity-end filters 28a, 28b disposed at opposite extremities 25a, 25b of the cavity optical path 24 and at least one optical gain region 30 positioned in the cavity optical path 24 between the cavity-end filters 28a, 28b.

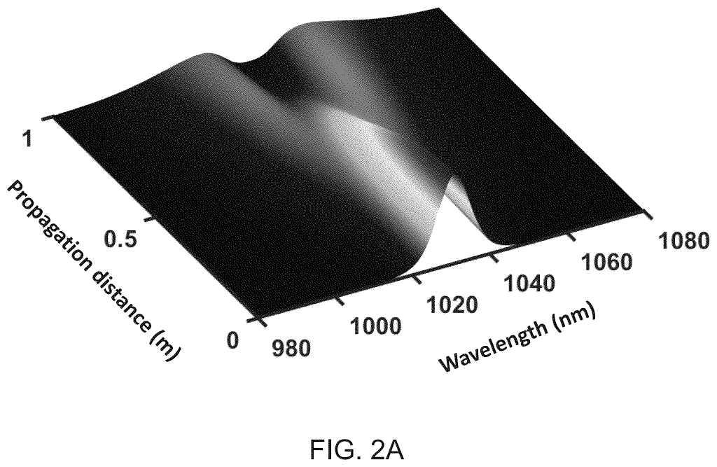

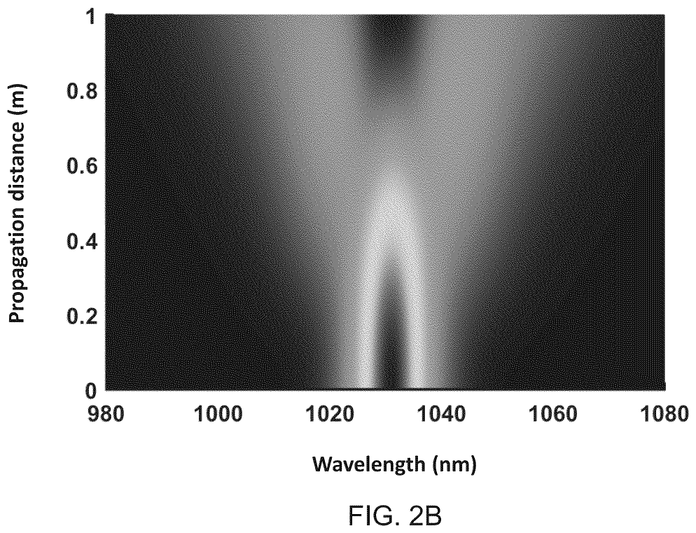

Spectral broadening refers to the increase of the number of wavelengths, i.e. the increase in the spectral contents of a light pulse as it propagates in a medium. In some embodiments, the spectral broadening of the light pulses may be the result of the so-called optical Kerr effect, which refers to circumstances in which the propagation of high intensity light pulses leads to nonlinear effects which modify the refractive index of the propagation medium. Different nonlinear effects may be the cause of the broadening of the spectrum, such as self-phase modulation, cross-phase modulation, four wave mixing and the like. In some embodiments, the spectral broadening of the light propagating along the optical path generally results from Self-Phase Modulation (SPM). SPM is a nonlinear optical effect whereby the propagation of an ultrashort pulse of light in a medium induces a change in the refractive index of this medium, due to the optical Kerr effect. This variation in refractive index produces a phase shift in the pulse, leading to a change in its spectral profile. By way of example, FIGS. 2A and 2B shows the spectral evolution of a Gaussian pulse being broadened by SPM while propagating in a medium.

In typical embodiments, the cavity optical path 24 is embodied by a length of optical fiber, which may be composed of a single optical fiber segment 26 or of a series of n different segments of optical fiber 26a, 26b, . . . , 26n that are fused, pigtailed or otherwise coupled to each other. Optical fibers are typically composed of a light guiding core and one or more cladding surrounding the core. A protective polymer coating may surround the outermost cladding. In typical embodiments, the optical fiber of fiber segments embodying the optical path is or are multi-clad, that is, have a plurality of claddings. The optical fiber or fiber segments is or are configured to guide the light pulses in a core mode, and optionally guide pump light in one or more cladding modes, as explained further below.

Each segment of optical fiber 26 of the cavity optical path 24 may be of one of a variety of optical fiber types. The core and/or cladding of the optical fiber may be made of glass such as silica or any type of oxide glass and may be made of pure glass or may be doped with one or more dopants. The optical fiber may or may not be made of a photosensitive material or be photosensitized prior to the writing of a Bragg grating therein. As such, co-doping the fiber with germanium, as is known in the art to enhance photosensitivity, is not necessarily required, although in some embodiments the fiber may be germanium-doped and hydrogen- or deuterium-loaded to enhanced photosensitivity. In some embodiments, the core and/or cladding of the optical fiber may alternatively be made of a crystalline material such as a sapphire, germanium, zinc selenide, yttrium aluminium garnet (YAG) or other crystalline materials with similar physical properties. In other embodiments, the core and/or cladding of the optical fiber may alternatively be made of low phonon energy glass such as a fluoride, chalcogenide or chalcohalide glass or other glass materials with similar physical properties. The low phonon energy glass medium can be of a variety of compositions, such as, but not limited to, doped or undoped fluoride glasses such as ZBLA, ZBLAN, ZBLALi, chalcogenide glasses such as As₂S₃ or As₂Se₃ or chalcohalide glasses.

In some embodiments, one or more of the optical fiber segments 26 are Polarization-Maintaining (PM) optical fibers. PM optical fibers have a strong built-in birefringence, that is, they are built so that the two orthogonal polarization modes of light propagate along the optical fiber at two distinct phase velocities. The segments of PM optical fibers may for example be PANDA type optical fibers, in which the birefringence is provided by stress rods of a glass composition differing from the core and cladding composition, disposed on opposite sides of the core. The stress rods are typically introduced in a preform prior to drawing into the PM optical fiber.

The polymer coating, sometimes referred to as the fiber jacket or fiber coating, may be made of any suitable polymer or hybrid polymer material. For example, standard optical fibers for telecommunication or fiber lasers are typically provided with an acrylate or fluoroacrylate-based coating. In other embodiments, the polymer coating may be made of a polyimide, a silicone, a polytetrafluoroethylene (e.g. Teflon™), an organically modified ceramic (e.g. Ormocer™) and the like. In some cases, a thin layer of a hermetic material, such as carbon or metal, can be present at the polymer-to-cladding interface.

As mentioned above, the resonator cavity 22 includes a first and a second cavity-end filters 28a, 28b disposed at opposite extremities 25a, 25b of the cavity optical path 24. It will be readily understood that the expressions “cavity-end” and “extremities” are used in this context to connote the functional boundaries of the resonator cavity 22 and are not necessarily correlated with the physical ends of the optical fiber segments hosting the cavity-end filters. The first and second cavity-end filters 28a, 28b have reflectivity profiles respectively centered on a first wavelength λ₁ and a second wavelength λ₂. In some implementations, the respective reflectivity profiles of the first and second cavity-end filters 28a, 28b are selected in view of the desired laser dynamics of the resonator cavity 22, as explained further below.

In some implementations, each one of the cavity-end filters 28a, 28b is embodied by a Fiber Bragg Grating (FBG), and may be referred to in the description below as the first and second cavity-end FBGs 28a, 28b. Throughout the present description, the expression “Bragg grating” is used to refer to a periodic or aperiodic refractive index pattern induced in a waveguide, the expression “Fiber Bragg grating” or “FBG” being used in the art when the waveguide is an optical fiber. An FBG allows light propagating into the host optical fiber to be reflected in a counterpropagating direction when its wavelength corresponds to the Bragg wavelength of the refractive index pattern, which is related to its period. A chirped fiber Bragg grating has a period, and therefore a Bragg wavelength, which varies as a function of the position along the fiber, defining a reflectivity profile spanning over one or more wavelength bands. The period profile of a chirped Bragg grating is also designated as its dispersion profile, as different wavelengths are reflected at distinct positions along the grating, subjecting them to different delays, therefore creating chromatic dispersion in the light pulse. The refractive index pattern can be designed to provide a dispersion profile tailored to the desired impact on the characteristics of the reflected light.

Although the description below refers mainly to first and second cavity-end FBGs 28a, 28b, it will be readily understood that in alternative embodiments the cavity-end filters 28a, 28b may be embodied by thin film filters deposited at the ends of the optical fiber segments at extremities of the optical path, or the like. In other variants, bulk or semi-bulk filters may be used. Furthermore, it will be readily understood that the designations of “first” and “second” cavity-end filters is used herein for ease of reference only and is not meant to impart a sequential preference in the operation of the first and second cavity-end filters.

In some implementations, the optical gain region or regions 30 may be embodied by a segment of optical fiber having an active core. As well known in the art, optical amplifications can be enabled by doping the core of an optical fiber with one or more rare-earth ions such as erbium ions (Er3+), ytterbium ions (Yb3+), thulium ions (Tm3+), holmium ions (Ho3+), dysprosium ions (Dy3+), praseodymium ions (Pr3+), neodymium ions (Nd3+) or any combination thereof. In the present description, the rare-earth dopants and/or other dopants may be referred to using the chemical element name of the corresponding oxide. For instance, one can refer to “erbium” or “ytterbium” dopant. One skilled in the art will understand that such elements are present in the optical fiber in their oxide form. Regarding the rare earth dopants, such as ytterbium for instance, one will use the terms “ytterbium”, “Yb³⁺”, “ytterbium oxide”, and “Yb₂O₃” interchangeably.

In some implementations, the rare-earth ions may be embedded in a conventional silica-based matrix. Otherwise, the matrix of the optical fiber can be a low phonons energy glass such as fluoride-, chalcogenide-, chalcohalide-telluride-based glass or the like. For instance, in some embodiments, the low phonon energy glass may be a zirconium fluoride glass having a composition including ZrF such as ZBLAN (ZrF/HfF, BaF₂, LaF₃, NaF, and AlF₃). In some other embodiments, the low phonon energy glass may be an indium fluoride glass having a composition including InF₃. In alternate embodiments, the low phonon energy glass may be an aluminum fluoride glass having a composition including AlF₃. In further embodiments, the low phonon energy glass may be a chalcogenide glass having a composition including As₂S₃, As₂Se₃, AsTe, AsSSe, AsSTe, GaLaS, GeAsS, GeAsSe or the like. Photonic crystal fibers, large mode area (LMA) fiber, and other types of specialty optical fiber may be used as host to the optical gain region 30 without departing from the scope of protection. It will be noted that in other variants, the optical gain region may be configured to provide gain without the need for doping with rare-earth ions. By way of example, in some variants the optical gain region 30 may provide optical gain via nonlinear effects such as stimulated Raman scattering or any other suitable nonlinear effect or combination thereof.

In some implementations, the light pulse generator 20 further includes at least one pump source 32 coupled to the at least one optical gain region 30. The pump source 32 may be embodied by any light source apt to generate a pump beam which can lead to a population inversion in the associated optical gain region 30. By way of example, the pump source 32 may be embodied by a fibered laser diode optically connected to the cavity optical path 24, for example via fusion splicing or through a WDM coupler 33 provided inside or outside of the resonator cavity 22, on one side of the gain region 30 or on the other. The pump beam preferably has a spectral profile adapted to the absorption profile of the optical gain region 30. By way of example, an Ytterbium-based optical gain region may be pumped with a pump beam in the 900 nm range (typically 976 nm or 920 nm).

The light pulse generator 20 further includes a light output 50 optically coupled to the first cavity-end filter 28a, outside of the resonator cavity 22. The light output 50 may be embodied by an end of the optical fiber 26a hosting the first cavity-end filter 28a or by an additional optical fiber segment connected thereto, defining an output optical path 51. An output coupler or any other suitable component may be provided to extract light from the light output 50. As will be readily understood by one skilled in the art, the light output 50 may be connected to an amplifier or any other device destined to receive the light pulses generated by the light pulse generator 20 according to the context of its usage.

The light pulse generator 20 further includes a pulse-recycling filter 40 which is spectrally selective and has a reflectivity profile centered on a third wavelength λ₃. The pulse recycling filter 40 is optically coupled to the second cavity-end filter 28b. As will be explained in detail below, the pulse-recycling filter 40 is configured to reflect a recycled light pulse 64 for a single pass through the gain region 30 and for extraction through the light output 50. The pulse-recycling filter 40 may be embodied by a Chirped Fiber Bragg grating, or CFBG, as defined above. Typically, the filter's absolute group velocity dispersion must be high enough (for example greater than about 4 ps²) to temporally stretch the recycled light pulse (for example greater than about 50 ps) in order to prevent sufficient nonlinear broadening to spectrally overlap with the first cavity-end filter 28a, at the filter 28a position, and destabilize the oscillator. If the light pulse generator 20 is implemented as a CPA seed source, the group velocity dispersion of the pulse-recycling filter 40 would be positive with the higher order dispersion components of the group velocity dispersion profile tuned to match the compressor after all subsequent amplifications. In some embodiments, a tuning mechanism 43 may be provided for tuning the group velocity dispersion profile as well as the reflectivity profile of the CFBG, for example through a change in strain or temperature of the optical fiber segment hosting the CFBG, or both, as known in the art. Examples of tuning mechanisms may for example be found in U.S. Pat. No. 6,937,793 (LELIEVRE et al), the entire contents of which being incorporated herein by reference.

Although the pulse-recycling filter is illustrated in the accompanying drawings as a CFBG, it will be readily understood that in other implementation, the pulse-recycling filter may take different forms. For example, the pulse-recycling filter may be embodied by a loop-fibered mirror including a filter and a dispersive line or other components or combination of components performing the desired reflection and dispersion functions. In another example, a circulator may be provided having ports optically coupled to the cavity light path, and an additional port coupled to the pulse-recycling filter and to a cavity-pulse reflector. In other variants, a chirped broadband mirror or a WDM coupler used in transmission and combined with an isolator and 50/50 coupler may be used. In free space implementation of the present light pulse generators, the pulse-recycling filter may for example be embodied by a Chirped Volume Bragg grating (CVBG). As one skilled in the art, the pulse-recycling filter may be embodied by any equivalent to the examples listed above or other components or combination of components performing the function of returning recycled light pulses as defined herein for a single pass through the gain region of the resonator cavity.

In different implementations, the pulse-recycling filter 40 may be positioned inside or outside of the resonator cavity 22. In some implementations, the light pulse generator 20 may include a time delay line 42, for example embodied by an additional length of optical fiber, in a recycling optical path 41 extending between the pulse-recycling filter 40 and second cavity filter 28b. In some embodiment, the recycling optical path 41 may be embodied by the same segment of optical fiber 26 hosting the second cavity-end filter 28b, while in other variants one or more additional optical fiber segments may be provided. The time delay line 42 has a length selected in view of the desired propagation delay of light travelling to and from the pulse-recycling filter 40. In some implementations, the time delay line 42 may be configured to either avoid or to provide additional spectral broadening of the recycled light pulses 64.

### Generation of Ultrashort Light Pulses

In some implementations, the light pulse generator 20 may be configured to generate ultrashort output light pulses based on the presence of two offset filters in a nonlinear laser cavity, a configuration known in the art as a “Mamyshev oscillator”.

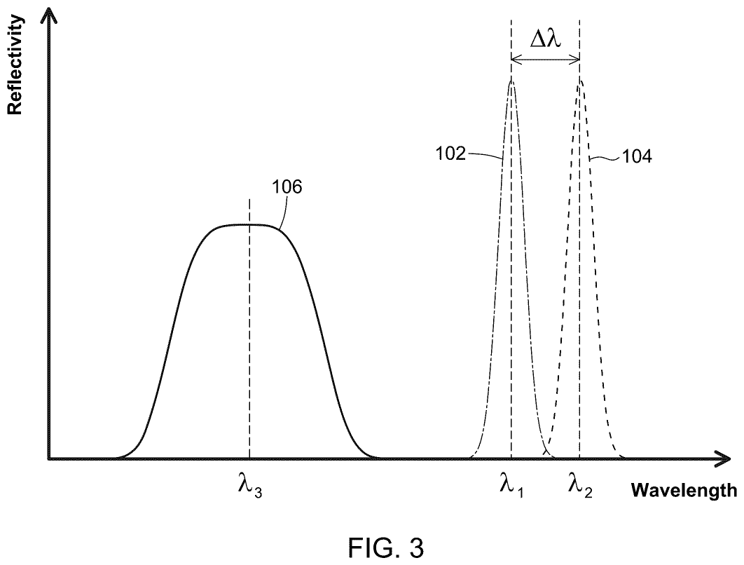

Referring to FIG. 3, there is shown an example of a reflectivity profile 102 of the first cavity-end FBG 28a, centered on a first Bragg wavelength λ₁, and of a reflectivity profile 104 of the second cavity-end FBG 28b, centered on a second Bragg wavelength λ₂. As can be observed, the Bragg wavelengths of the first and second cavity-end FBGs 28a, 28b are spectrally offset by a spectral spacing Δλ=|λ1−λ2|. In other words, the reflectivity profile of the first cavity-end FBGs 28a is detuned from the reflectivity profile of the second cavity-end FBGs 28b.

Referring back to FIG. 1A, the generation of output light pulses 66 in the illustrated configuration may be achieved as described below.

Seed light pulses 60 may be provided in the resonator cavity 22 by means known in the art. By way of example, in some implementations seed light pulses may be generated from the gain region 30 by modulating the pump power injected by the pump source 32. In some embodiments a nonlinear external feedback mechanism (SESAM, nonlinear rotation of the polarization, loop-mirror, etc.) may be provided at the start-up stage and interrupted once the desired resonance is achieved. In other implementations, seed light pulses 60 may be injected in the resonator cavity 22 from an external light source (not shown). Adding a saturable absorber (not shown) to the resonator cavity 22 may also be considered. The saturable absorber could be a physical element (semiconductors, chemical compounds, carbon nanotubes, etc.) or an artificial effect (multi-modal interference, Kerr self-focusing, etc.). In some variants, an acousto-optic modulator (not shown) or other type of fast modulator could be added to the light pulse generator 20. Once injected or created in the resonator cavity 22, the seed light pulses 60 become cavity light pulses 62 as they circulate within the resonator cavity 22.

As can be appreciated, the spectral contents of a cavity light pulse 62 reflected at the first wavelength λ₁ by the first cavity-end FBG 28a tend to be spectrally broadened during its propagation along the cavity optical path 24 to encompass the second wavelength λ₂ of the second cavity-end FBG 28b, and vice versa, thereby allowing the cavity light pulses 62 to be reflected back-and-forth between the first and second cavity-end FBGs 28a and 28b, when the optical gain region 30 is pumped with the pump beam and when the resonator cavity 22 is mode locked. As such, only light pulses that are amplified enough to experience spectral broadening as they propagate through the optical gain region 30 can oscillate within the resonator cavity 22. At both cavity-end FBGs 28a and 28b, the spectral portion of a cavity light pulse 62 outside of the reflectivity profile of the corresponding FBG is transmitted through the FBG and extracted from the resonator cavity 22, forming extracted light pulses 63a, 63b. In the example of FIG. 1A, the extracted light pulses 63a exiting the resonator cavity 22 through the first cavity-end FBG 28a propagate through the output optical path and form part of the output light pulses 66. Their spectrum includes the second wavelength λ₂ as well as other wavelengths outside of the reflectivity profile 102 of the first cavity-end FBG 28a. The extracted light pulses 63b exiting the resonator cavity 22 through the second cavity-end FBG 28b have a spectrum including the first wavelength λ₁ as well as other wavelengths outside of the reflectivity profile 104 of the second cavity-end FBG 28b.

In the embodiment of FIG. 1A, the pulse-recycling filter 40 is positioned outside of the resonator cavity 22, in the recycling optical path 41. As shown in FIG. 3, the pulse-recycling filter 40 has a reflectivity profile 106 centered on a third wavelength λ₃. A spectral portion of the extracted light pulses 63b reaching the pulse-recycling filter 40 within the corresponding reflectivity profile is returned towards the resonator cavity 22, effectively “recycling” light at or around the third wavelength λ₃, forming the recycled light pulse 64. The recycled light pulse 64 enters the resonator cavity 22 through the second cavity-end FBG 28b and makes a single trip across the resonator cavity 22, making a single pass through the gain region 30. It is then transmitted through the first cavity-end FBG 28a, as its wavelength is outside of the reflectivity profile of the first cavity-end FBG 28a. The recycled light pulse is therefore extracted from the resonator cavity 22 when reaching the first cavity-end FBG 28a. Upon reaching the light output 50, the recycled light pulse 64 then defines an output light pulse 66 at the third wavelength.

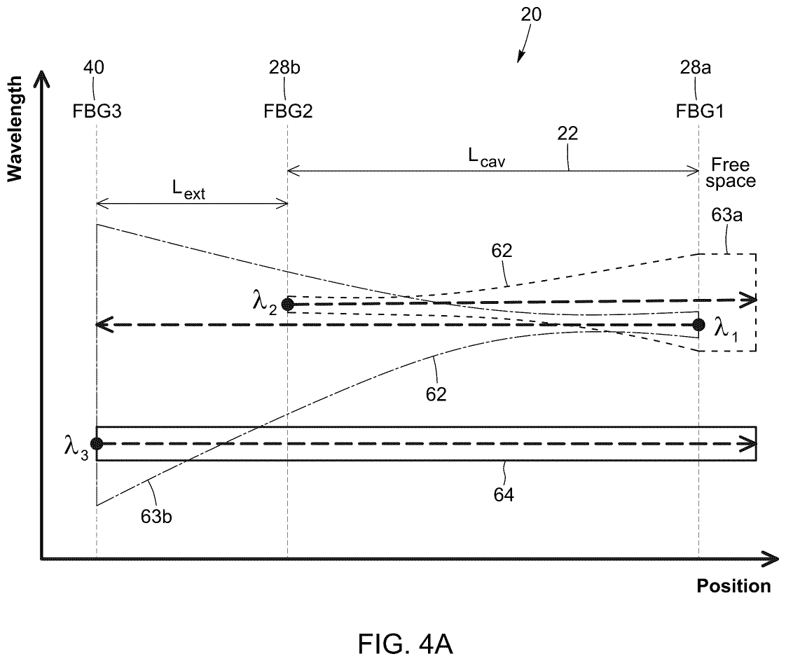

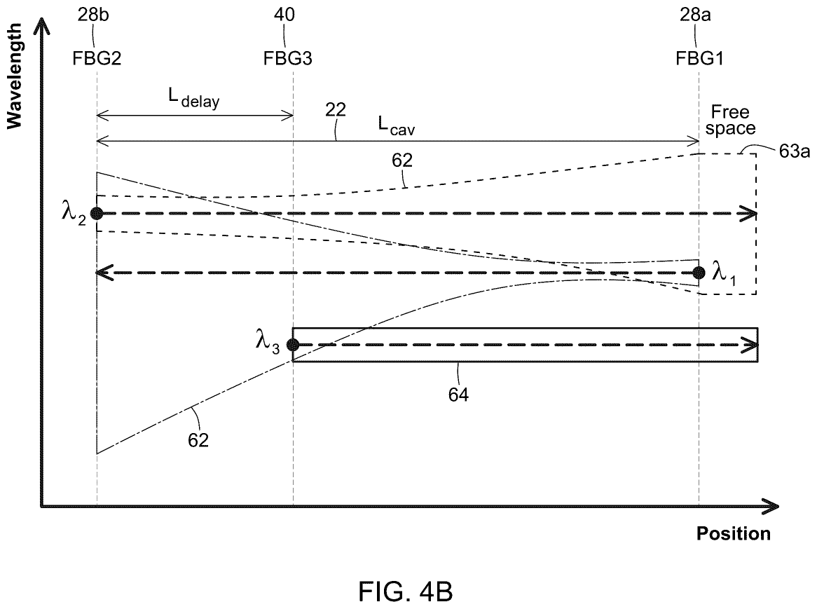

Referring to FIG. 4A, the evolution of the spectral contents of light circulating through the light pulse generator 20 of the example of FIG. 1A is schematically illustrated. It will be readily understood that reference to the right or left directions in this paragraph and the remainder of the present description is made only to facilitate consultation of the drawings and are in no way meant to impart a preferential orientation to light pulse generators according to real world embodiments. As can be seen from this example, cavity light pulses 62 at the second wavelength λ₂ reflected by the second cavity-end FBG 28b are spectrally broadened (and amplified) as they propagate towards the right in the resonator cavity 22, and light having the resulting broadened spectral contents, minus the portion overlapping with the reflectivity profile of the first cavity-end FBG 28a which is reflected back in the resonator cavity 22, is extracted from the resonator cavity 22 through the first cavity-end FBG 28a and forms extracted light pulses 63a. Cavity light pulses 62 at the first wavelength λ₁ reflected by the first cavity-end FBG 28a are spectrally broadened (and amplified) as they propagate towards the left in the resonator cavity, and light having the resulting broadened spectral contents, minus the portion overlapping with the reflectivity profile of the second cavity-end FBG 28b which is reflected back in the resonator cavity 22, is extracted from the resonator cavity 22 through the second cavity-end FBG 28b and forms extracted light pulses 63b. The portion of the spectral contents extracted through the second cavity-end FBG 28b which intersects with the reflectivity profile of the pulse-recycling filter 40 forms a recycled light pulse 64 which is reflected back through the second cavity-end FBG 28b, propagates along the optical path of the resonator cavity 22 and is amplified by the gain region, and is finally extracted from the resonator cavity 22 through the first cavity-end FBG 28a. In the illustrated example, the chirp or dispersion of the pulse-recycling filter 40 is designed so that the recycled light pulse 64 has a peak power low enough to avoid significant broadening as it propagates through the optical fibers of the light pulse generator. In some implementations, the recycled light pulse may be intense enough to experience some spectral broadening.

In some implementations, to achieve a stable configuration with the required output parameters, the gain saturation caused by the pulse coming from a pulse-recycling filter are considered since it will affect the MO's spectral broadening and subsequently, the feedback from the pulse-recycling filter. If the gain saturation is too high, the MO will lose mode-locking. The light pulse generator is preferably designed in such a way that the gain saturation self-balance with spectral broadening and the energy feedback of the pulse-recycling filter to achieve steady state. The gain and spontaneous emission wavelength dependencies relative to the spectral position of the cavity-end filters may also be considered. This task may be achieved by extensive numerical simulations based on the generalized nonlinear Schrödinger equation in which the gain is computed with population equations and appropriate gain cross sections.

As an example, this principle can be understood from FIG. 4C with the following description. In the illustrated configuration, the active and passive optical fiber segments 26A, 26B and 26C within the resonator cavity 22 are kept relatively short to achieve a high repetition rate (>20 MHz). In the optical fiber segment 26B embodying the gain region 30, the ytterbium ions energy populations are inverted with the right pump level to provide enough gain to achieve the required nonlinear spectral broadening for a stable oscillation between cavity-end filters 28a, 28b. The pulse-recycling filter 40 is positioned near the short wavelengths (1030 nm) where an output is desired. Under those conditions, however, the stretched recycled light pulse 64 coming from the pulse-recycling filter 40 would experience much more gain and induce strong gain saturation relative to the cavity light pulses 62 coming from the cavity-end filters 28a, 28b, which have wavelength near the longer wavelengths (1050-1060 nm) where there is less gain. This effect is enhanced even more by the large bandwidth of the pulse-recycling filter 40, which causes feedback with higher energy relative to the narrow bandwidths of the cavity-end filter 28a, 28b. This is good for the pulse energy output but if the gain saturation gets out of control, the feedback from the pulse-recycling filter 40 would cause a loss of mode-locking or instabilities within the resonator cavity 22 due to a reduced nonlinear spectral broadening.

In one implementation of such a scenario, one solution may be to adjust the length of the time delay line 42 to provide just enough spectral broadening of light travelling from the second cavity-end filter 28b to the pulse-recycling filter 40 so that the reflectivity profile 106 of the pulse recycling filter 40 is aligned near the left edge of the spectrum 63′ of the incoming extractive light pulse 63, while providing an overlap with the full pulse-recycling filter 40 bandwidth 106. In that case, a higher gain saturation would lead to a reduced pulse energy of the cavity light pulses 62 travelling from the gain region 30 to the second cavity-rend filter 28b, reducing the spectral broadening of the extracted light pulses 63b reaching the pulse-recycling filter 40 which would immediately reduce the pulse energy and bandwidth 64′ of the recycled light pulses 64 in the forward direction. This reduction in pulse energy of the recycled light pulses 64 would then reduce gain saturation, counteracting the initial change in gain. This logic shows a self-balancing behavior which makes the laser output stable with the right design considerations, as illustrated here. Due to the overall system complexity, the design process may advantageously be performed through multiple simulations and can yield various considerations for different configurations or desired outcome.

### Descriptions of Embodiments

Referring to FIG. 1B, there is shown a configuration of a light pulse generator 20 for generating light pulses according to variant differing from the variant of FIG. 1A in that the pulse-recycling filter 40 is provided inside the resonator cavity 22. In this variant, the light pulse generator 20 includes a resonator cavity 22 comprising a cavity optical path 24 apt to induce a spectral broadening of light propagating therealong. The cavity optical path 24 may be composed of a single optical fiber 26 or of a series of n different segments of optical fiber 26a, 26b, . . . , 26n that are fused, pigtailed or otherwise coupled to each other. The resonator cavity 22 includes first and second cavity-end filters 28a, 28b disposed at opposite extremities 25a, 25b of the cavity optical path 24. The cavity-end filters 28a, 28b have reflectivity profiles respectively centered on a first wavelength λ₁ and a second wavelength λ₂. The cavity-end filters 28a, 28b may for example be embodied by unchirped or chirped FBGs, by thin film filters deposited at the ends of the optical fiber segments 26 at the extremities 25a, 25b of the cavity optical path 24, by bulk or semi-bulk filters, or the like. The resonator cavity 22 further includes at least one optical gain region 30 positioned in the cavity optical path 24 between the cavity-end filters 28a, 28b. In the illustrated variant, a single gain region is illustrated, by way of example. The optical gain region or regions 30 may be embodied by a length of optical fiber having an active core. In other variants the optical gain region 30 may provide optical gain via nonlinear effects such as stimulated Raman scattering or any other suitable nonlinear effect or combination thereof. A light output 50 is optically coupled to the first cavity-end filter 28a, outside of the resonator cavity 22. One or more pump sources 32 is or are optically coupled to the gain region or regions 30 to provide one or more pump signals in a forward-pumping or backward-pumping configuration with respect to the direction propagation of light towards the light output 50. The light pulse generator 20 further includes a pulse-recycling filter 40 optically coupled to the second cavity-end filter 28b.

In this embodiment, the pulse-recycling filter 40 is positioned inside of the resonator cavity 22, between the second cavity-end filter 28b and the gain region 30. The pulse-recycling filter 40 may be embodied by a chirped FBG, as defined above, directly written in one of the optical fiber segments of the cavity optical path. In another variant, a full circulator may be provided having a first port connected to the cavity optical path on the side of the second cavity-end filter 28b, a second port connected to a recycling optical path hosting the pulse-recycling filter and a cavity-pulse reflector having a spectral profile selected to reflect the cavity pulses back into the full circulator, and a third port connected to the rest of the cavity optical path. In some variants, the pulse-recycling filter and the cavity-pulse filter induce different delays in the propagation of the recycled pulses and cavity pulse, providing a temporal separation therebetween. The pulse-recycling filter 40 has a reflectivity profile centered on a third wavelength λ₃ and configured to return a recycled light pulse into the resonator cavity 22. The length of the optical fibers embodying the cavity optical path in this variant may be selected to provide the desired propagation delay between the recycled light pulses and the cavity light pulses.

Referring to FIG. 4B, the evolution of the spectral contents of light circulating through the light pulse generator 20 of the example of FIG. 1B is schematically illustrated. As can be seen from this example, cavity light pulses 62 at the second wavelength λ₂ reflected by the second cavity-end FBG 28b are unaffected by the pulse-recycling filter 40 and are spectrally broadened and amplified as they propagate towards the right in the resonator cavity 22. Light having the resulting broadened spectral contents, minus the portion overlapping with the reflectivity profile of the first cavity-end FBG 28a which is reflected back in the resonator cavity 22, is extracted from the resonator cavity 22 through the first cavity-end FBG 28a and forms extracted light pulses 63a. Cavity light pulses 62 at the first wavelength λ₁ reflected by the first cavity-end FBG 28a are spectrally broadened and amplified as they propagate towards the left in the resonator cavity 22. Upon reaching the pulse-recycling filter 40, the portion of the spectral contents of the cavity light pulse 62 which intersects with the reflectivity profile of the pulse-recycling filter 40 forms a recycled light pulse 64 which is reflected towards the right in the illustrated resonator cavity 22. The spectral portion of the cavity light pulse which is transmitted through the pulse-recycling filter 40 reaches the second cavity-end filter 28b and the portion of overlapping with the reflectivity profile of the second cavity-end FBG 28b is reflected back in the resonator cavity 22, continuing it's back-and forth travel through the resonator cavity as the cavity light pulse 62. Both the cavity light pulse 62 and the recycled light pulse 64 propagate along the optical path of the resonator cavity 22 and are amplified by the gain region 30. The recycled light pulse 64 is extracted from the resonator cavity 22 through the first cavity-end FBG 28a, alongside a portion of the cavity light pulse as explained above.

The light pulse generator configurations illustrated in FIG. 1A or 1B yield an oscillator generating output light pulses which includes separate cavity light pulses at the second wavelength λ₂ and recycled light pulses at the third wavelength λ₃, at the same repetition rate. In some implementations, it may be desired to isolate the light pulses at the third wavelength λ₃, i.e. the recycled light pulses, for output by the light pulse generator 20. In some implementations, one or more output pulse separator configured to select the recycled pulses as output pulses for extraction may be provided for this purpose. This may for example be accomplished by taking advantage of either the polarization, spectral (wavelength) or timing characteristics of light. Combinations of different methods may also be used. Each method has its own advantages and drawbacks, as explained further below.

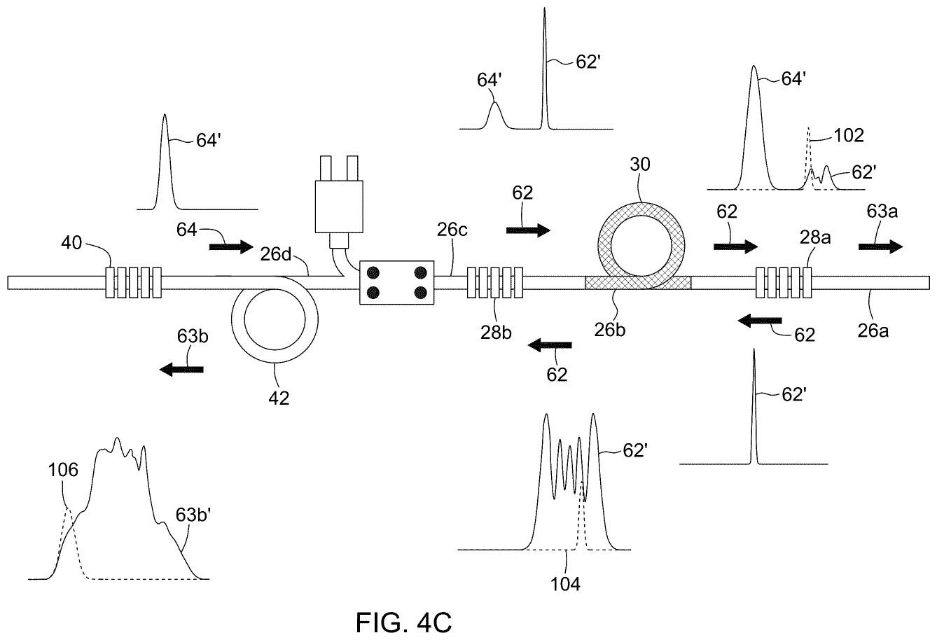

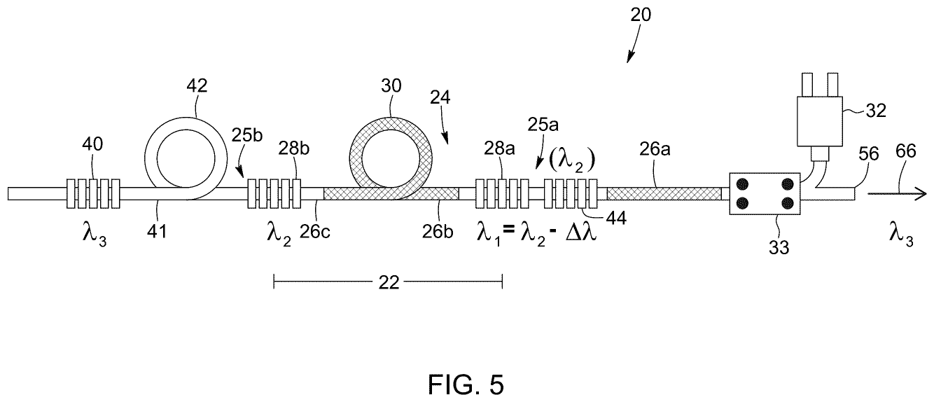

Referring to FIG. 5, a configuration of a light pulse generator 20 for generating light pulses according to another variant is illustrated. The light pulse generator 20 includes a resonator cavity 22 comprising a cavity optical path 24 apt to induce a spectral broadening of light propagating therealong. The cavity optical path 24 may be composed of a single optical fiber 26 or of a series of n different segments of optical fiber 26a, 26b, . . . , 26n that are fused, pigtailed or otherwise coupled to each other. The resonator cavity 22 includes first and second cavity-end filters 28a, 28b disposed at opposite extremities 25a, 25b of the cavity optical path 24. The cavity-end filters 28a, 28b have reflectivity profiles respectively centered on a first wavelength λ₁ and a second wavelength λ₂. The cavity-end filters 28a, 28b may for example be embodied by unchirped or chirped FBGs, by thin film filters deposited at the ends of the optical fiber segments 26 at the extremities 25a, 25b of the cavity optical path 24, by bulk or semi-bulk filters, or the like. The resonator cavity further includes at least one optical gain region 30 positioned in the cavity optical path 24 between the cavity-end filters 28a, 28b. In the illustrated variant, a single gain region 30 is illustrated, by way of example. The optical gain region or regions 30 may be embodied by a length of optical fiber having an active core. In other variants the optical gain region 30 may provide optical gain via nonlinear effects such as stimulated Raman scattering or any other suitable nonlinear effect or combination thereof. A light output 50 is optically coupled to the first cavity-end filter 28a, outside of the resonator cavity 22. One or more pump sources 32 is or are optically coupled to the gain region or regions 30 to provide one or more pump signals in a forward-pumping or backward-pumping configuration with respect to the direction propagation of light towards the light output 50. The light pulse generator 20 further includes a pulse-recycling filter 40 optically coupled to the second cavity-end filter 28b. In this embodiment, the pulse-recycling filter 40 is positioned outside of the resonator cavity 22. The pulse-recycling filter 40 may be embodied by a chirped FBG, as defined above, a loop-fibered mirror, or the like. The pulse-recycling filter 40 has a reflectivity profile centered on a third wavelength λ₃ and is configured to return a recycled light pulse into the resonator cavity 22. A time delay line 42 may further be provided between the pulse-recycling filter 40 and the second cavity-end filter 28b.

The light pulse generator 20 illustrated in FIG. 5 further includes a stop-band filter 44 provided outside of the resonator cavity 22 and coupled to the extremity 25a of the optical path opposite to the pulse-recycling filter 40. In some implementations, the stop-band filter 44 is embodied by a tilted or slanted FBG. In other variants, the stop-band filter 44 may for example be embodied by dichroic, stop-band or WDM coupler filter. The stop-band filter is configured to suppress the cavity light pulses while allowing the recycled light pulses through. This may for example be accomplished by one or more filter elements having a spectrally selective profile configured to transmit at least light at the third wavelength λ₃ to the light output 50 while suppressing light at the second wavelength λ₂, at least sufficiently such that it loses enough energy to avoid being spectrally broadened to the point that it would overlap the third wavelength λ₃. The light pulses in this configuration are generated in the same manner as in the configuration of FIG. 1A, with the stop-band filter 44 providing additional spectral filtering of light outputted from the resonator cavity 22 to separate the light pulses generated from the resonator cavity 22 from the ones generated from the pulse-recycling filter 40. In implementations of this configuration, the light pulse generator 20 is preferably designed such that there is no significant spectral overlap between the cavity light pulses extracted from the first cavity-end filter 28a and the recycled light pulses. In some variants, this configuration may require more nonlinear spectral broadening than the configuration of FIG. 1A to provide enough bandwidth to sustain both the pulse-recycling filter 40 and the resonator cavity 22.

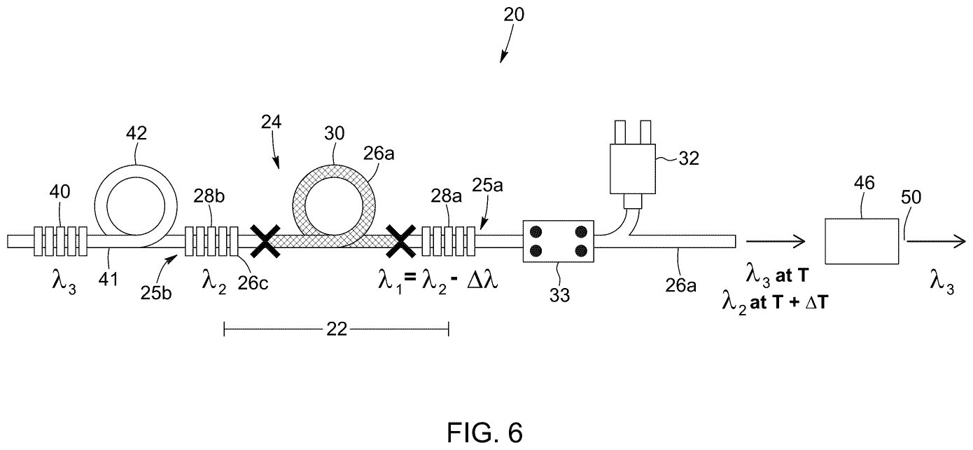

Referring to FIG. 6, a configuration of a light pulse generator 20 for generating light pulses according to another variant is illustrated. The light pulse generator 20 includes a resonator cavity 22 comprising a cavity optical path 24 apt to induce a spectral broadening of light propagating therealong. The cavity optical path 24 may be composed of a single optical fiber 26 or of a series of n different segments of optical fiber 26a, 26b, . . . , 26n that are fused, pigtailed or otherwise coupled to each other. The resonator cavity 22 includes first and second cavity-end filters 28a, 28b disposed at opposite extremities 25a, 25b of the cavity optical path 24. The cavity-end filters 28a, 28b have reflectivity profiles respectively centered on a first wavelength λ₁ and a second wavelength λ₂. The cavity-end filters 28a, 28b may for example be embodied by unchirped or chirped FBGs, by thin film filters deposited at the ends of the optical fiber segments 26 at the extremities 25a, 25b of the cavity optical path 24, by bulk or semi-bulk filters, or the like. The resonator cavity further includes at least one optical gain region 30 positioned in the cavity optical path 24 between the cavity-end filters 28a, 28b. In the illustrated variant, a single gain region 30 is illustrated, by way of example. The optical gain region or regions 30 may be embodied by a length of optical fiber having an active core. In other variants the optical gain region 30 may provide optical gain via nonlinear effects such as stimulated Raman scattering or any other suitable nonlinear effect or combination thereof. A light output 50 is optically coupled to the first cavity-end filter 28a, outside of the resonator cavity 22. One or more pump sources 32 is or are optically coupled to the gain region or regions 30 to provide one or more pump signals in a forward-pumping or backward-pumping configuration with respect to the direction propagation of light towards the light output 50. The light pulse generator 20 further includes a pulse-recycling filter 40 optically coupled to the second cavity-end filter 28b. In this embodiment, the pulse-recycling filter 40 is positioned outside of the resonator cavity 22. The pulse-recycling filter 40 may be embodied by a chirped FBG, as defined above, a loop-fibered mirror, or the like. The pulse-recycling filter 40 has a reflectivity profile centered on a third wavelength λ₃ and configured to return a recycled light pulse into the resonator cavity 22. A time delay line 42 may further be provided between the pulse-recycling filter 40 and the second cavity-end filter 28b.

The light pulse generator 20 illustrated in FIG. 6 further includes a pulse picker 46 couple to the light output 50 of the light pulse generator 20. The pulse picker may for example be embodied by an acousto-optic modulator or an electro-optic modulator that selects a subset of pulses based on a triggering mechanism controlled electronically. Such an embodiment relies on a time-base separation of the recycled light pulses generated by the pulse-recycling filter 40 from those extracted light pulses generated by the resonator cavity 22. In the embodiment illustrated in FIG. 6, the length of the delay line provided in the recycling optical path may be selected to temporally separate the recycled light pulses from the cavity light pulses. The length of the time delay line 42 may be adapted to match the pulse-picker rise time. If present, spectral broadening from propagation through the time delay line 42 should be considered. In embodiments where the pulse-recycling filter in provided inside the cavity, such as for the configuration shown in FIG. 1B, the pulse recycling filter may be positioned along the linear optical path at a position selected to temporally separate the recycled light pulses from the cavity light pulses. By way of example if the pulse-recycling filter is at a position midway between the two cavity-end filters in terms of optical fiber lengths, the recycled pulses will be temporally at the “midpoint” between two cavity pulses, which would facilitate their temporal separation.

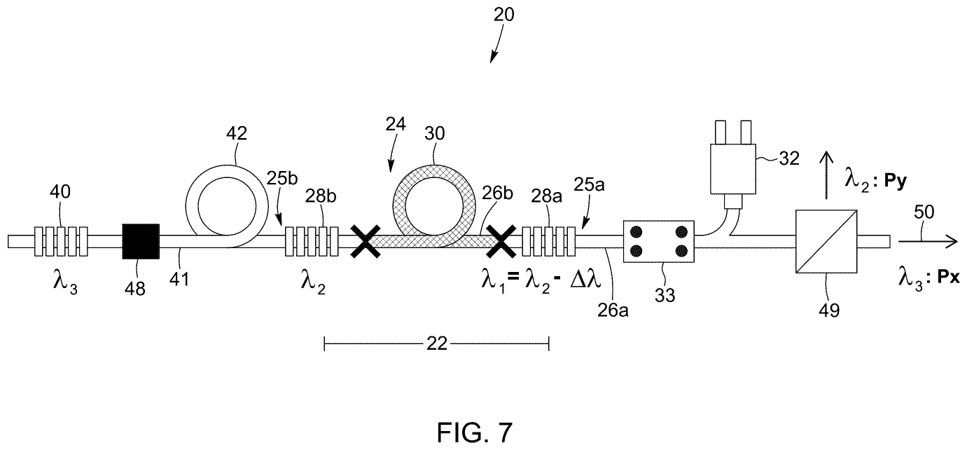

Referring to FIG. 7, a configuration of a light pulse generator 20 for generating light pulses according to another variant is illustrated. The light pulse generator 20 includes a resonator cavity 22 comprising a cavity optical path 24 apt to induce a spectral broadening of light propagating therealong. The cavity optical path 24 may be composed of a single optical fiber 26 or of a series of n different segments of optical fiber 26a, 26b, . . . , 26n that are fused, pigtailed or otherwise coupled to each other. The resonator cavity 22 includes first and second cavity-end filters 28a, 28b disposed at opposite extremities 25a, 25b of the cavity optical path 24. The cavity-end filters 28a, 28b have reflectivity profiles respectively centered on a first wavelength λ₁ and a second wavelength λ₂. The cavity-end filters 28a, 28b may for example be embodied by unchirped or chirped FBGs, by thin film filters deposited at the ends of the optical fiber segments 26 at the extremities 25a, 25b of the cavity optical path 24, by bulk or semi-bulk filters, or the like. The resonator cavity further includes at least one optical gain region 30 positioned in the cavity optical path 24 between the cavity-end filters 28a, 28b. In the illustrated variant, a single gain region 30 is illustrated, by way of example. The optical gain region or regions 30 may be embodied by a length of optical fiber having an active core. In other variants the optical gain region 30 may provide optical gain via nonlinear effects such as stimulated Raman scattering or any other suitable nonlinear effect or combination thereof. A light 50 is optically coupled to the first cavity-end filter 28a, outside of the resonator cavity 22. One or more pump sources 32 is or are optically coupled to the gain region or regions 30 to provide one or more pump signals in a forward-pumping or backward-pumping configuration with respect to the direction propagation of light towards the light output 50. The light pulse generator 20 further includes a pulse-recycling filter 40 optically coupled to the second cavity-end filter 28b. In this embodiment, the pulse-recycling filter 40 is positioned outside of the resonator cavity 22. The pulse-recycling filter 40 may be embodied by a chirped FBG, as defined above, a loop-fibered mirror, or the like. The pulse-recycling filter 40 has a reflectivity profile centered on a third wavelength λ₃ and configured to return a recycled light pulse into the resonator cavity 22. A time delay line 42 may further be provided between the pulse-recycling filter 40 and the second cavity-end filter 28b.

In this configuration, the separation of the recycled light pulses generated through the pulse-recycling filter 40 from the extracted light pulses 63a generated from the resonator cavity 22 relies on the polarization state of the recycled light pulses and the extracted light pulses. In one example, the optical fiber or fibers 26 of the resonator cavity 22 are polarization maintaining fibers as explained above, whereby the cavity light pulses are linearly polarized. A polarization rotator 48 is provided outside of the resonator cavity 22 in the recycling optical path 41 leading to the pulse-recycling filter 40. The polarization rotator 48 is configured to rotate the polarization of the recycled light pulses 64 to be orthogonal to the polarization of the cavity light pulses 62. The polarization may for example be embodied by a Faraday rotator, or in some particular cases, one or several quarter-wave plates positioned at 45° with respect to the light polarization orientation of the main cavity pulses. A polarization beamsplitter 49 is optically coupled to the light output and configured to select the recycled pulses as output pulses for extraction based on their polarization state. In some implementations, the polarization beamsplitter 49, such as for example a Wollaston prism, a Nicol prism, a Glan-Foucault prism, a Glan-Taylor prism, a Glan-Thompson prism or the like, is provided between the resonator cavity 22 and the light output 50, and separates the incoming pulses according to their respective polarization and direct light in the polarization state associated with the recycle pulses to the light output 50. In other implementations different polarization-based components may alternatively be used, such as for example polarizing fibers.

In some implementation, light pulse generators having a ring configuration are provided. Such a configuration may provide more design flexibility to achieve specific requirements not limited to the FBGs achievable parameters.

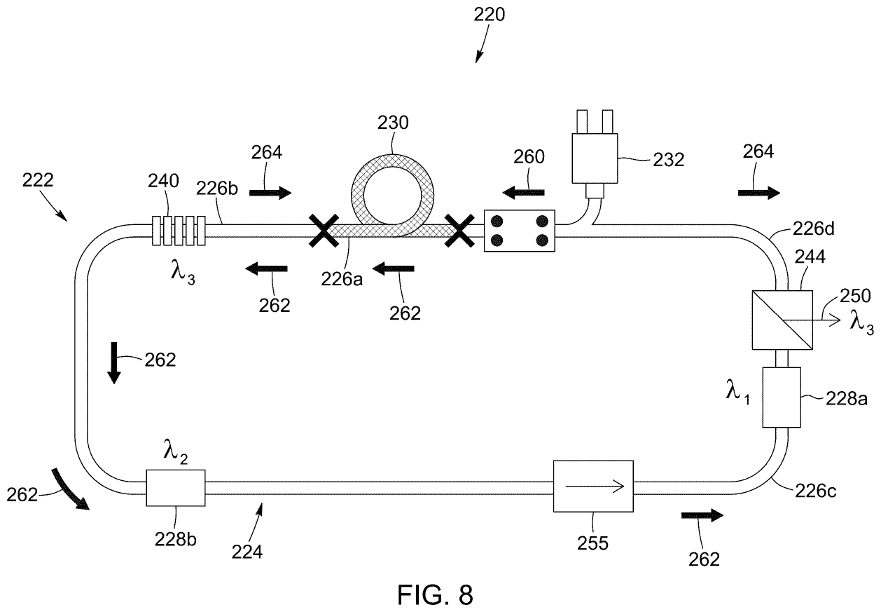

Referring to FIG. 8, there is shown an example of a light pulse generator 220 having such a configuration. In the illustrated embodiment, the light pulse generator 220 includes a ring cavity 222 defining a ring-shaped optical path 224 apt to induce a spectral broadening of light propagating therealong. The cavity 222 may be composed of a single optical fiber 226 or of a series of n different segments of optical fiber 226a, 226b, . . . , 226n that are fused, pigtailed or otherwise coupled to each other. The light pulse generator 220 further includes a light output 250 configured to extract output pulse out of the ring cavity 222, as explained further below. The light pulse generator 220 further includes at least one optical gain region 230 positioned within the ring cavity 222. In the illustrated variant, a single gain region 230 is illustrated, by way of example. The optical gain region or regions 230 may be embodied by a length of optical fiber having an active core. In other variants the optical gain region 230 may provide optical gain via nonlinear effects such as stimulated Raman scattering or any other suitable nonlinear effect or combination thereof. One or more pump sources 232 is or are optically coupled to the gain region or regions 230 to provide one or more pump signals in a forward-pumping or backward-pumping configuration with respect to the direction propagation of light towards the light output 250. The light pulse generator further includes first and second transmissive filters 228a, 228b extending across the optical path 224 of the ring cavity 222. In the illustrated embodiment, the first and second transmissive filters 228a, 228b are disposed between the gain region 230 and the light output 250, on opposite sides of the gain region 230. The transmissive filters 228a, 228b have transmission profiles respectively centered on a first wavelength λ₁ and a second wavelength λ₂. The transmissive filters 228a, 228b may for example be embodied by unchirped or chirped FBGs with a circulator. In some implementations, two slanted FBGs in transmission respectively configured to extract from the circular optical path the lowband and highband portions of the spectra surrounding the corresponding central wavelength λ₁ and λ₂ could be used. Other embodiments may make use of thin film filters, bulk or semi-bulk filters, or the like.

An optical isolator 255 is provided in the optical path 224 of the ring cavity 222. The position and direction of the isolator imposes the light circulation direction around the ring cavity 222. In the illustrated embodiment, the isolator 255 is disposed between the second transmissive filter 228b and the light output 250 to prevent light from travelling clockwise towards the second transmissive filter 228b. The propagation direction of the cavity light pulses 262 in the ring cavity 222 of this variant is therefore counterclockwise. Accordingly, the first and second transmissive filters 228a and 228b are disposed and oriented such that they allow through light at their respective transmission wavelengths travelling in the counterclockwise direction. It will be readily understood that in other variants, the ring cavity 222 may be designed such that the light pulse propagation direction is clockwise.

Still referring to FIG. 8, the light pulse generator 220 further includes a pulse-recycling filter 240 optically coupled to the ring resonator 222, and disposed, in the illustrated embodiment, between the second transmissive filter 228b and the gain region 230, so as to reflect incoming light circulating counterclockwise in the illustrated configuration into a clockwise direction. In other words, the recycling filter 240 reflecting cavity light pulses 262 travelling from the first transmissive filter 228a and through the gain region 230 back again through the gain region 230 towards the first transmissive filter 228a. The pulse-recycling filter 240 may be embodied by a chirped FBG, as defined above. The pulse-recycling filter 240 has a reflectivity profile centered on a third wavelength λ₃ and is configured to reflect a recycled light pulse for a pass through the gain region 230 and extraction through the light output 250. In that embodiment, the selective output 250 for λ₃ is positioned between the gain region 230 and the first filter 228a. It is understood that if the filter 228a also allows the light at the third wavelength λ₃ to pass through in the clockwise direction, the selective output 250 for λ₃ could be positioned between the filter 228a and the isolator 255. In some implementations, the filter 228a may act as the output 250 by extracting light at wavelength λ₃ from the cavity.

The light pulse generator 220 illustrated in FIG. 8 further includes a spectrally sensitive output coupler 244 for extracting light pulses from the ring cavity 222 to the light output 250. The spectrally sensitive output coupler may for example be embodied by a dichroic filter, a coupler WDM filter or the like. The spectrally sensitive output coupler 244 has a spectrally selective profile configured to direct at least light at the third wavelength λ₃ to the light output 250 while allowing light at the second wavelength λ₂ to continue propagation along ring cavity 222.

In operation for this embodiment and other ring configurations, seed light pulses 260 may be provided in the ring cavity 222 by means known in the art, such as for example through modulation of the pump power injected by the pump source 232, by providing a nonlinear external feedback mechanism at the start-up stage, by injection in the ring cavity 222 from an external light source, or by adding a saturable absorber to the ring cavity 222. Once injected or created in the ring cavity 222, the seed light pulses 260 become cavity light pulses 262 as they circulate counterclockwise around the ring cavity 222. Beginning arbitrarily at the first transmissive filter 228a, the spectral portion of a cavity light pulse 262 at the first wavelength λ₁ is transmitted through the first transmissive filter 228a and is spectrally broadened as it circulates along the optical path 224 and through the gain region 230, to eventually include spectral contents at the second and third wavelengths λ₂ and λ₃. Upon reaching the pulse-recycling filter 240, the spectral portion of the cavity light pulses 262 at the third wavelength λ₃ is reflected in the clockwise direction as a recycled light pulse 264, which makes an additional pass through the gain region 230 and is then transmitted through the first transmissive filter 228a, continuing its clockwise travel until reaching the spectrally selective output coupler 244 which extracts the recycled pulse 264 to the light output 250 as an output pulse 264. The spectral portion of the cavity pulse 262 outside of the reflectivity profile of the recycling filter 240 continues travelling counterclockwise as a cavity pulse 262 travelling along the cavity path 224 and being broadened until it reaches the second transmissive filter 228b, which allows through the spectral portion of the cavity pulse at the second wavelength for circulation around the cavity path 224 towards the first transmissive filter 228a. The spectral contents of the cavity pulse 262 is again broadened as is circulates within the second half of the cavity so as to include light at the first wavelength λ₁ for transmission through the first transmissive filter 228a for another pass around the ring cavity 222. In some embodiments, the second half of the cavity may optionally include a gain region.

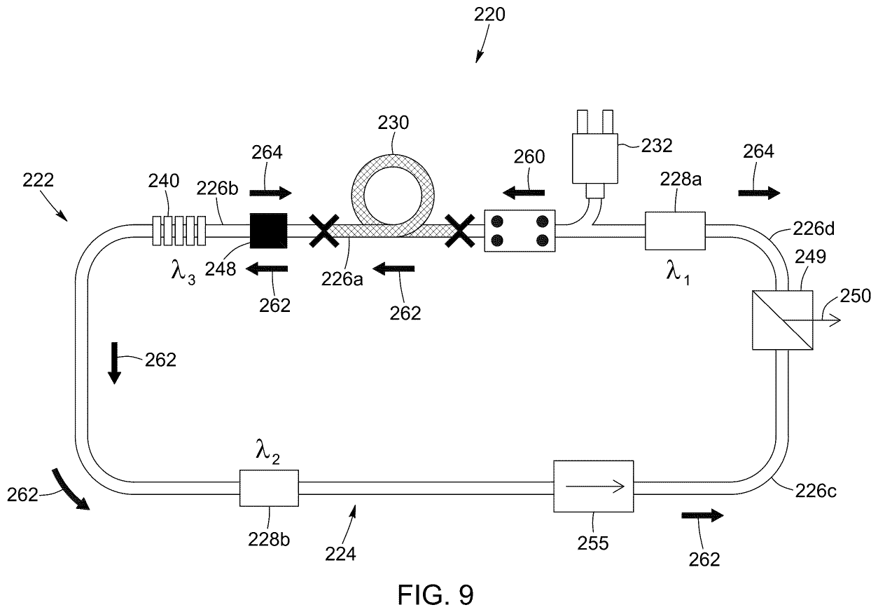

Referring to FIG. 9, a configuration of a light pulse generator 20 with a ring configuration for generating light pulses according to another variant is illustrated. In the illustrated embodiment, the light pulse generator 220 includes a ring cavity 222 defining a ring-shaped optical path 224 apt to induce a spectral broadening of light propagating therealong. The cavity 222 may be composed of a single optical fiber 226 or of a series of n different segments of optical fiber 226a, 226b, . . . , 226n that are fused, pigtailed or otherwise coupled to each other. The light pulse generator 220 further includes a light output 250 configured to extract output pulse out of the ring cavity 222, as explained further below. The light pulse generator 220 further includes at least one optical gain region 230 positioned within the ring cavity 222. In the illustrated variant, a single gain region 230 is illustrated, by way of example. The optical gain region or regions 230 may be embodied by a length of optical fiber having an active core. In other variants the optical gain region 230 may provide optical gain via nonlinear effects such as stimulated Raman scattering or any other suitable nonlinear effect or combination thereof. One or more pump sources 232 is or are optically coupled to the gain region or regions 230 to provide one or more pump signals in a forward-pumping or backward-pumping configuration with respect to the direction propagation of light towards the light output 250. The light pulse generator 220 further includes first and second transmissive filters 228a, 228b extending across the optical path 224 of the ring cavity 222. In the illustrated embodiment, the first and second transmissive filters 228a, 228b are disposed between the gain region 230 and the light output 250, on opposite sides of the gain region 230. The transmissive filters 228a, 228b have transmission profiles respectively centered on a first wavelength λ₁ and a second wavelength λ₂. The transmissive filters 228a, 228b may for example be embodied by unchirped or chirped FBGs with a circulator, slanted FBGs in transmission, by thin film filters, by bulk or semi-bulk filters, or the like.

An optical isolator 255 is provided in the optical path 224 of the ring cavity 222 between one of the transmissive filters 228a, 228b and the light output 250. The position and direction of the isolator imposes the light circulation direction around the ring cavity 222. In the illustrated embodiment, the isolator is disposed between the second transmissive filter 228b and the light output 250 to prevent light from travelling clockwise towards the second transmissive filter 228b. The light pulse propagation direction in the ring cavity 222 of this variant is therefore counterclockwise. Accordingly, the first and second transmissive filters 228a and 228b are disposed and oriented such that they allow through light at their respective transmission wavelengths travelling in the counterclockwise direction. It will be readily understood that in other variants, the ring cavity 222 may be designed such that the light pulse propagation direction is clockwise.

Still referring to FIG. 9, the light pulse generator 220 further includes a pulse-recycling filter 240 optically coupled to the ring resonator 222, and disposed, in the illustrated embodiment, between the second transmissive filter 228b and the gain region 230, so as to reflect incoming light circulating counterclockwise in the illustrated configuration into a clockwise direction. In other words, the recycling filter 240 reflecting light pulses travelling from the first transmissive filter 228a and through the gain region 230 back again through the gain region 230 towards the first transmissive filter 228a. The pulse-recycling filter 240 may be embodied by a chirped FBG, as defined above. The pulse-recycling filter 240 has a reflectivity profile centered on a third wavelength λ₃ and is configured to reflect a recycled light pulse 264 for a pass through the gain region 230 and extraction through the light output 250. In that embodiment, it is understood that the filter 228a allows the light at the third wavelength λ₃ to pass through in the clockwise direction within the appropriate polarization state. In some other embodiment, the selective output 250 for λ₃ could have been put between the filter 228a and the gain region 230 to remove that design constraint. In some implementations, the filter 228a may act as the output 250 by extracting light at wavelength λ₃ from the cavity.

In the illustrated configuration of FIG. 9, the optical fiber or fibers 226 of the ring cavity 222 are polarization maintaining fibers as explained above, whereby the cavity light pulses are linearly polarized. A Faraday rotator 248 is provided inside of the ring cavity 222, between the pulse-recycling filter 240 and the gain region 230. The Faraday rotator 248 is configured to rotate the polarization of the recycled light pulses 264 to be orthogonal to the polarization of the cavity light pulses 262. The polarization of the recycled light pulse becomes orthogonal to the signal propagating in the counterclockwise direction in the PM optical fiber after having propagated in the clockwise direction in the Faraday rotator. On either side of the Faraday rotator, the axes of the PM fiber are rotated 45 degrees with respect to each other. A polarization beamsplitter 249, is provided at the light output 250, to separate the incoming pulses according to their respective polarization and direct light in the polarization state associated with the recycle pulses to the light output 250.

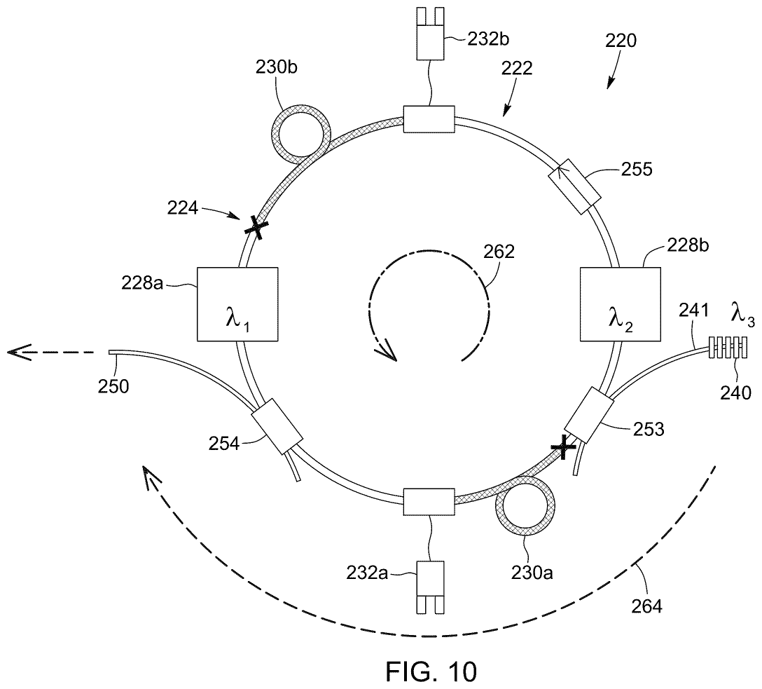

Referring to FIG. 10, a configuration of a light pulse generator 220 with a ring configuration for generating light pulses in which the pulse-recycling filter is positioned outside of the resonator cavity is illustrated.

In the illustrated embodiment, the light pulse generator 220 includes a ring cavity 222 defining a ring-shaped optical path 224 apt to induce a spectral broadening of light propagating therealong. The cavity 222 may be composed of a single optical fiber 226 or of a series of n different segments of optical fiber 226a, 226b, . . . , 226n that are fused, pigtailed or otherwise coupled to each other. The light pulse generator 220 further includes a light output 250 configured to extract output pulse out of the ring cavity 222, as explained further below. The light pulse generator 220 further includes at least one optical gain region 230 positioned within the ring cavity 222. In the illustrated variant, two gain regions 230a and 230b are illustrated, by way of example. The optical gain region or regions 230 may be embodied by a length of optical fiber having an active core. In other variants the optical gain region 230 may provide optical gain via nonlinear effects such as stimulated Raman scattering or any other suitable nonlinear effect or combination thereof. One or more pump sources 232 is or are optically coupled to the gain region or regions 230 to provide one or more pump signals in a forward-pumping or backward-pumping configuration with respect to the direction propagation of light towards the light output 250. Two such pump sources 232a and 232b are shown in the illustrated configuration, each respectively associated with one of the gain regions. It will be readily understood that in other variants a same pump source may be used to pump more than one gain region. The light pulse generator 220 further includes first and second transmissive filters 228a, 228b extending across the optical path 224 of the ring cavity 222. In the illustrated embodiment, the first and second transmissive filters 228a, 228b are disposed such that the gain regions 230a, 232 are disposed on opposite sides of the ring cavity 222 with respect to the transmissive filter 228a, 228b. The transmissive filters 228a, 228b have transmission profiles respectively centered on a first wavelength λ₁ and a second wavelength λ₂. The transmissive filters 228a, 228b may for example be embodied by unchirped or chirped FBGs, or the like.

An optical isolator 255 is provided in the optical path 224 of the ring cavity 222 The position and direction of the isolator imposes 255 the light circulation direction around the ring cavity 222. In the illustrated embodiment, the isolator is disposed following the second transmissive filter 228b along the counterclockwise direction to prevent light from travelling clockwise towards the second transmissive filter 228b. The light pulse propagation direction in the ring cavity 222 of this variant is therefore counterclockwise. Accordingly, the first and second transmissive filters 228a and 228b are disposed and oriented such that they allow through light at their respective transmission wavelengths travelling in the counterclockwise direction. It will be readily understood that in other variants, the ring cavity 222 may be designed such that the light pulse propagation direction is clockwise.

Still referring to FIG. 10, the light pulse generator 220 further includes a pulse-recycling filter 240. The pulse-recycling filter is provided in a recycling optical path 241, for example segment of optical fiber, optically coupled to the ring resonator 222 through a recycling coupler 253, for example a WDM coupler. The pulse-recycling filter 240 may be embodied by a chirped FBG, as defined above. The pulse-recycling filter 240 has a reflectivity profile centered on a third wavelength λ₃ and is configured to reflect a recycled light pulse 264 for a pass through the gain region 230 and extraction through the light output 250. In the illustrated embodiment, the recycling coupler 253 is configured to extract a spectral portion of the cavity light pulses 262 which includes the third wavelength into the recycling optical path 241. The recycling coupler 253 is positioned between the one of the gain region 230a and the second transmissive filter 228b along the propagation direction of the cavity light pulses 262, so as to separate a portion of the cavity pulses circulating counterclockwise in the illustrated configuration towards the pulse-recycling filter 240, which reflects light at the third wavelength back into the ring cavity 222 along a clockwise direction. In other words, the recycling filter 240 reflecting light pulses travelling from the first transmissive filter 228a and through the gain region 230a back again through the gain region 230a towards the first transmissive filter 228a. An output coupler 254, for example a WDM coupler, is provided in a path of the recycle light pulses after their pass through the gain region 230a. The output coupler 254 is configured to extract the recycled light pulses, at the third wavelength, to an output optical fiber segment embodying the light output 250. Both the recycling coupler 253 and the output coupler 254 may for example be embodied by fused couplers, side-polished fibers, planar lightwave circuits, bulk-optics components, or the like.

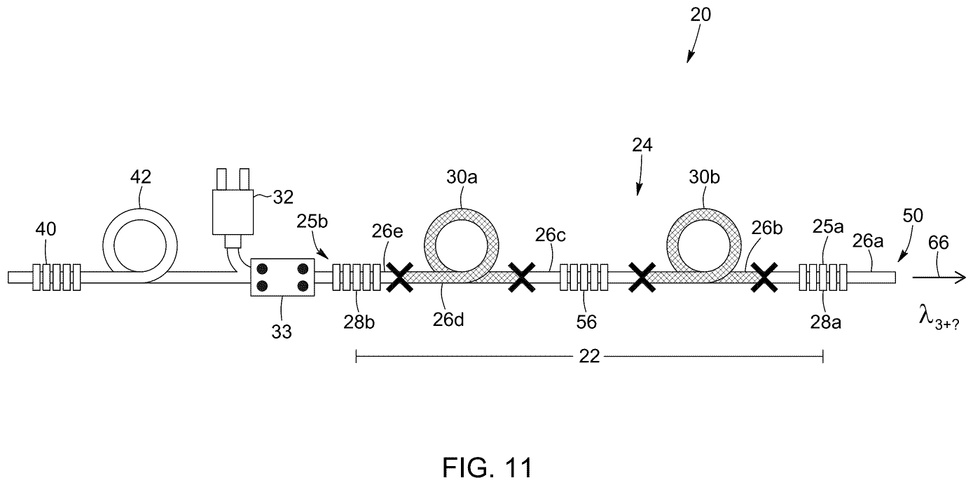

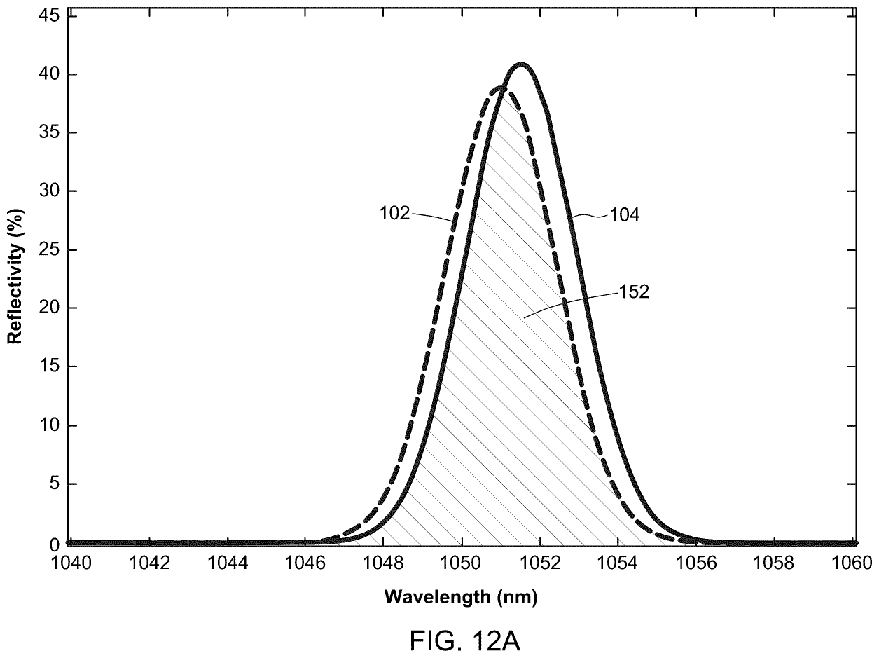

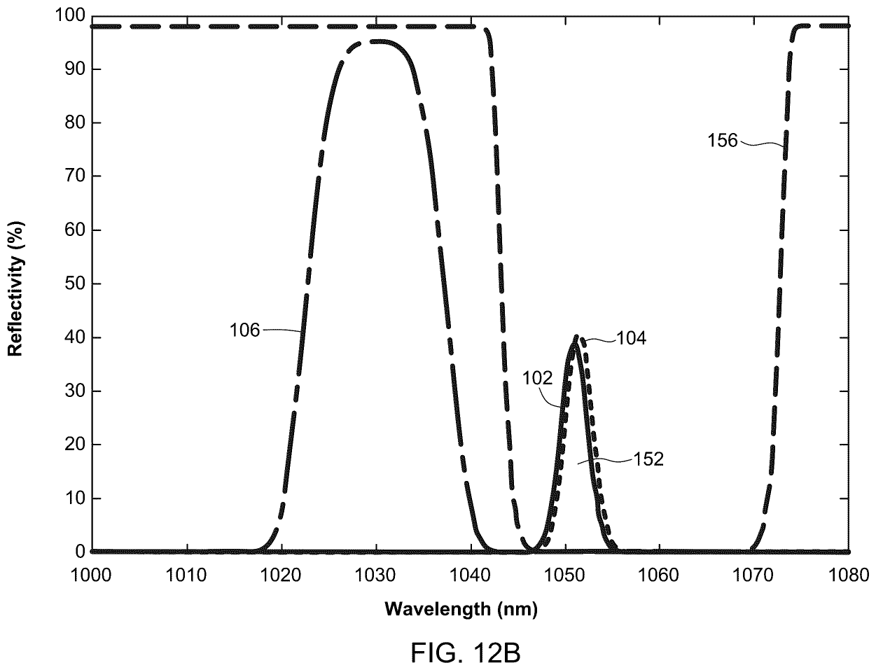

Referring to FIGS. 11, 12A and 12B, there is shown an embodiment of a light pulse generator 20 based on a resonator cavity 22 operating differently than the Mamyshev oscillator configuration of FIG. 1A. In this variant, the light pulse generator 20 includes a resonator cavity 22 comprising a cavity optical path 24 apt to induce a spectral broadening of light propagating therealong. The cavity optical path 24 may be composed of a single optical fiber 26 or of a series of n different segments of optical fiber 26a, 26b, . . . , 26n that are fused, pigtailed or otherwise coupled to each other.

The resonator cavity 22 includes first and second cavity-end filters 28a, 28b disposed at opposite extremities 25a, 25b of the cavity optical path 24. The cavity-end filters 28a, 28b are preferably embodied by cavity end FBGs 28a, 28b. With additional reference to FIGS. 12A and 12B, each cavity-end FBG 28a, 28b has a refractive index pattern designed to provide a corresponding reflective spectral band 102, 104. In some embodiments, the reflective spectral bands 102, 104, substantially overlap, thereby defining an overlap spectral range 152. In some implementations, the first and second cavity-end FBGs 28a and 28b have identical or nearly identical reflectivity profiles, that is, their corresponding reflective spectral bands 102, 104 completely or almost completely overlap, for example overlapping over about 90% or more of the reflective spectral bands of the FBGs. The shapes and reflectivity levels of the reflective spectral bands 102, 104 of the two FBGs may be identical or different.

Two optical gain regions 30a, 30b are positioned in the cavity optical path 24 between the cavity-end FBGs 28a, 28b. In the illustrated embodiment, a single pump source 32 is used to pump both optical gain regions 30a, 30b and is coupled to one of the extremities 25b of the cavity optical path 24 using a WDM coupler 33. One or more pump sources 32 is or are optically coupled to the gain region or regions 30 to provide one or more pump signals in a forward-pumping or backward-pumping configuration with respect to the direction propagation of light towards the light output 50. In the illustrated embodiment the pump source 32 is configured to pump both optical gain regions 30a and 30b. Other gain region and pump configurations may be used without departing from the scope of protection.

The light pulse generator 20 of this embodiment further includes a blocking filter 56 positioned along the resonator cavity 22 between the cavity-end FBGs 28a, 28b. The blocking filter 56 is configured to remove light at wavelengths within a blocking spectral range 156 (see FIG. 12B) from the cavity optical path 24. Wavelengths within the blocking spectral range 156 are therefore not reflected in a counterpropagating direction in the core, but instead directed outside of the core of the segment of optical fiber hosting the blocking filter 56. The blocking spectral range 156 includes at least the overlap spectral range 152, as will be explained further below. In some implementations, the blocking spectral range 156 is composed of the overlap spectral range 152 of the cavity-end FBGs 28a, 28b, and wavelengths immediately above the overlap spectral range 152. In other variants, the blocking spectral range 156 is composed of the overlap spectral range 152 of the cavity-end FBGs 28a, 28b, and wavelengths immediately below the overlap spectral range 152. It will be noted that in some variants the overlap spectral range may not coincide with an end portion of the blocking spectral range and may be at another location within the blocking spectral range, inasmuch as the light pulse generator is configured to provide sufficient spectral broadening of light to enable its operation as will be described further below. In some implementations, the blocking filter 56 may be a slanted FBG provided in the core of the host fiber. In some variants, the blocking filter 56 may be embodied by a long period grating (LPG).

An output 50 is optically coupled to the first cavity-end filter 28a, outside of the resonator cavity 22.

The light pulse generator 20 further includes a pulse-recycling filter 40 optically coupled to the second cavity-end filter 28b. In this embodiment, the pulse-recycling filter 40 is positioned outside of the resonator cavity 22. The pulse-recycling filter 40 may be embodied by a chirped FBG, as defined above. The pulse-recycling filter 40 has a reflectivity profile centered on a third wavelength λ₃ and configured to return a recycled light pulse into the resonator cavity 22. A time delay line 42 may further be provided between the pulse-recycling filter 40 and the second cavity-end filter 28b.

The process of generating ultrashort light pulses using the light pulse generator 20 according to the embodiment of FIG. 11 is explained below. Further details and explanations can be found in international application number PCT/CA2024/050092, the entire contents of which is incorporated herein by reference. In the example described below, both cavity-end FBGs 28a, 28b are assumed to have reflectivity bands which completely overlap, and the blocking spectral range 156 of the blocking filter 56 includes the overlap spectral range 152a and beyond.

The process begins with the circulation of a seed light pulse along the cavity optical path 24. Preferably, the light pulse generator 20 includes a starting mechanism apt to launch the seed light pulse along a core mode of the cavity optical path 24. The seed light pulse has an initial spectral profile which depends on the nature and operation of the starting mechanism. The initial spectral profile preferably includes wavelengths within the blocking spectral range 152. As the seed light pulse propagates along the cavity optical path 24, it is reflected back and forth between the first and second cavity-end FBGs 28a, 28b, the travelling light defining a cavity light pulse of growing intensity and varying spectral contents.

Initially, the cavity pulse propagates in a first direction, which is towards the right in the illustrated embodiment, along the cavity optical path 24 on the left side of the resonator cavity 22 and through the first optical gain region 30a, gaining intensity from the optical gain. As this propagation occurs, the spectrum of the cavity light pulse is broadened. The broadened spectral profile of the cavity pulse may include wavelengths shorter and longer than the wavelengths of the initial spectral profile, some of which extending beyond the blocking spectral range 152. Upon reaching the blocking filter 56, the spectral components of the cavity pulse within the blocking spectral range are extracted from the cavity optical path 24, leaving only the wavelengths outside of the blocking range 156. As the cavity light pulse continues propagating towards the right along the cavity optical path 24 in the right side of the resonator cavity 22, it is amplified by the second optical gain region 30b, and spectrally broadened to again extend to shorter and higher wavelengths than those allowed through by the blocking filter 56, now including higher wavelengths extending within the blocking spectral range 156 and the overlap spectral band 152. Upon reaching the first cavity-end FBG 28a, only the wavelengths within the corresponding reflective spectral band 150a are reflected, transmitting all other wavelengths through to the light output 50. In some implementations, light at the transmitted wavelengths may define output light pulse having an output spectral profile having output wavelengths. In the illustrated example, the output wavelengths of the output light pulses 66 stemming from the cavity light pulses mainly include wavelengths immediately adjacent the reflective spectral band 50a of the first cavity-end FBG 28a on the blue (shorter) side, as well as lower intensity light peaks at wavelengths on the red (longer) side.

The reflected cavity light pulse, now having a spectral profile corresponding to the reflectivity band 102 of the first cavity-end FBG 28b, then makes another pass along the cavity optical path 24, this time travelling in a second direction opposite the first direction, towards the left in the illustrated embodiment. As it propagates along the right side of the cavity and through the second optical gain region 30b, the cavity light pulse 62 is again amplified and spectrally broadened. Upon reaching the blocking filter 56, all wavelengths within the blocking spectral range 156 are extracted from the cavity optical path 24, again leaving only the wavelengths outside of the blocking range in the cavity light pulse. The light cavity pulse then propagates along the left side of the cavity optical path 24, towards the left, and is spectrally broadened and amplified by the first optical gain region 30a.

Upon reaching the second cavity-end FBG 28b, the spectral portion of the cavity light pulse within the reflective spectral band 104 of the second cavity-end FBG 28b is reflected back along the resonator cavity 22, and the cycle begins again. The spectral portion of the cavity light pulse outside of the reflective spectral band 104 of the second cavity-end FBG 28b are transmitted though, defining an extracted light pulse propagating in the recycling light path 41. In the illustrated embodiment, the extracted light pulse mainly include wavelength immediately adjacent the reflective spectral band 104 of the second cavity-end FBG 28b on the blue (shorter) side. A spectral portion of the extracted light pulses 63b reaching the pulse-recycling filter 40 within the corresponding reflectivity profile is returned towards the resonator cavity 22, effectively “recycling” light at or around the third wavelength λ₃, forming the recycled light pulse. The pulse-recycling filter 40 is preferably dispersive and designed to stretch the recycled light pulse and manage spectral broadening so as to avoid an overlap of the spectral profile of the travelling recycled light pulse with the reflectivity profiles of the first and second cavity FBGs 28a, 28b and of the blocking filter 56. The recycled light pulse enters the resonator cavity 22 through the second cavity-end FBG 28b and makes a single trip across the resonator cavity 22, making a single pass through both gain regions 30a and 30b. It is then extracted from the resonator cavity 22 when reaching the first cavity-end FBG 28a, adding light at the third wavelength to the spectral contents of the output light pulse 66. In some implementations, an output pulse separator separating the recycled light pulses from the cavity light pulses at the light output 50 of the light pulse generator 20 main provided, such as the spectral-based, polarization-based or time-base schemes described above.

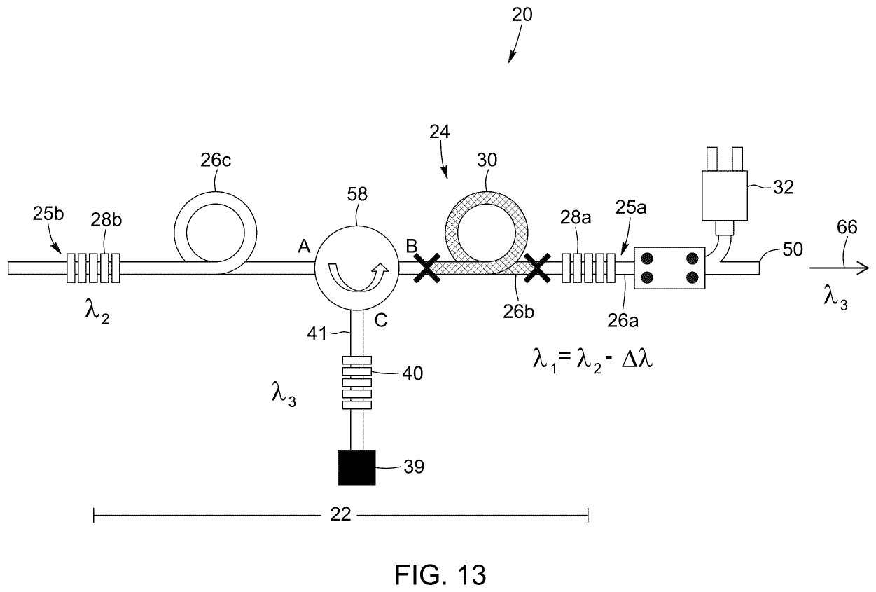

In some implementations, the pulse-recycling filter may be used along with a circulator inside the cavity. Referring to FIG. 13 shows an example of such a configuration. In this variant, the light pulse generator 20 includes a resonator cavity 22 comprising a cavity optical path 24 apt to induce a spectral broadening of light propagating therealong. The cavity optical path 24 may be composed of a single optical fiber 26 or of a series of n different segments of optical fiber 26a, 26b, . . . , 26n that are fused, pigtailed or otherwise coupled to each other. The resonator cavity 22 includes first and second cavity-end filters 28a, 28b disposed at opposite extremities 25a, 25b of the cavity optical path 24. The cavity-end filters 28a, 28b have reflectivity profiles respectively centered on a first wavelength λ₁ and a second wavelength λ₂. The cavity-end filters 28a, 28b may for example be embodied by unchirped or chirped FBGs, by thin film filters deposited at the ends of the optical fiber segments 26 at the extremities 25a, 25b of the cavity optical path 24, by bulk or semi-bulk filters, or the like. The resonator cavity 22 further includes at least one optical gain region 30 positioned in the cavity optical path 24 between the cavity-end filters 28a, 28b. In the illustrated variant, a single gain region is illustrated, by way of example. The optical gain region or regions 30 may be embodied by a length of optical fiber having an active core. In other variants the optical gain region 30 may provide optical gain via nonlinear effects such as stimulated Raman scattering or any other suitable nonlinear effect or combination thereof. An output 50 is optically coupled to the first cavity-end filter 28a, outside of the resonator cavity 22. One or more pump sources 32 is or are optically coupled to the gain region or regions 30 to provide one or more pump signals in a forward-pumping or backward-pumping configuration with respect to the direction propagation of light towards the light output 50.

The light pulse generator 20 further includes a pulse-recycling filter 40 optically coupled to the resonator cavity 22. The pulse-recycling filter 40 may be embodied by a chirped FBG, as defined above. The pulse-recycling filter 40 has a reflectivity profile centered on a third wavelength λ₃. In this embodiment, the pulse-recycling filter 40 provided in a recycling optical path 41, preferably embodied by one or more segment of optical fiber. The recycling optical path 41 is coupled to the cavity optical path 24 between the second cavity-end filter 28b and the gain region 30 through a full optical circulator 58. The full optical circulator 58 has three ports: Port A is connected to the cavity optical path 26c on the side of the second cavity-end filter 28b, Port C is connected to the recycling optical path 41, and Port B is connected to the cavity optical path 24 on the side of the gain region 30. The full optical circulator 58 works in both directions, that is, light is directed from ports B to A, C to B, and A to C. The full optical circulator may be embodied by a single or multiple devices performing the circulating function described above. A cavity pulse reflector 39 is provided in the recycling optical path 41 to reflect at least the cavity light pulses for continued circulation through the cavity. In the illustrated variant, the cavity pulse reflector is positioned at the end of the recycling optical path and can be a mirror reflecting all light not selected by the pulse-recycling filter back to the cavity optical path. In other variants, the cavity pulse reflector may be positioned at another location along the recycling optical path.

The light pulse generator 20 of the configuration of FIG. 13 generates output pulses as follows. Cavity light pulses 62 reaching port A of the full optical circulator 58 from the left side of the resonator cavity 22 are directed to port C and propagates in the recycling optical path 41. A spectral portion of these pulses overlapping with the reflectivity profile of the pulse-recycling filter 40 is reflected back towards the full optical circulator 58, forming recycled cavity pulses 64, while the cavity pulse reflector 39 reflects back the cavity light pulses. Upon reaching Port C of the full optical circulator 58, the recycled cavity pulses 64 a directed to Port B and propagate towards the first cavity-end filter 28a in the right-side portion of the resonator cavity 22. The spectral portion of the recycled pulses 64 at the third wavelength λ₃ and at other wavelengths outside of the reflectivity profile of the first cavity-end filter 28a are transmitted through the first cavity-end filter 28a towards the light output 50, forming the output light pulses 66. The spectral portion of the cavity pulses 62 overlapping with the reflectivity profile of the first cavity-end filter 28a is reflected towards the left in the illustrated embodiment. These cavity light pulses 62 are spectrally broadened and amplified. Upon reaching Port B of the full optical circulator 58, the cavity light pulses 62 are directed to Port A and continue their propagation towards the left of the resonator cavity 22. The spectral portion of the cavity light pulses 62 reaching the second cavity-end filter 28b is reflected back into the resonator cavity 22 so that another cycle may begin.

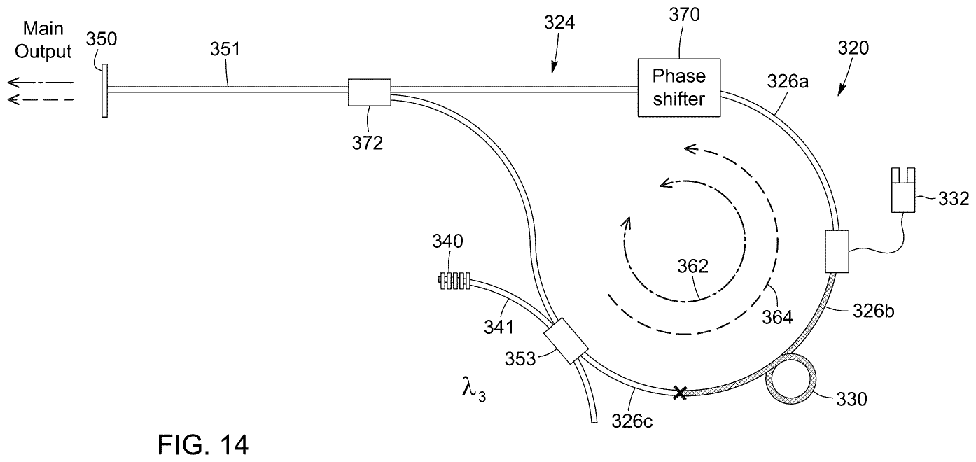

In some embodiments, the light pulse generator may have a configuration differing from the Mamyshev oscillators described above. Referring to FIG. 14, there is shown an embodiment in which the light pulse generator 320 includes a Nonlinear Amplifying Loop Mirror (NALM) generating main light pulses. In the illustrated embodiment, the NALM includes a loop optical path 324 supporting the propagation of main light pulses therearound in both a clockwise direction and counterclockwise direction. The loop optical path 324 may be composed of a single optical fiber 326 or of a series of n different segments of optical fiber 326a, 326b, . . . , 326n that are fused, pigtailed or otherwise coupled to each other.

The NALM further includes at least one optical gain region 330 positioned within the loop optical path 324. In the illustrated variant, a single gain region 330 is illustrated, by way of example. The optical gain region or regions 330 may be embodied by a length of optical fiber having an active core. In other variants the optical gain region 330 may provide optical gain via nonlinear effects such as stimulated Raman scattering or any other suitable nonlinear effect or combination thereof. One or more pump sources 332 is or are optically coupled to the gain region or regions 330 to provide one or more pump signals in a forward-pumping or backward-pumping configuration.

A non-reciprocal phase shifter 370 is positioned within the loop optical path 324. The non-reciprocal phase shifter may for example be embodied by a Faraday rotator or an appropriate material having a Verdet constant and one or multiple waveplates One example is provided in [“A design for a non-reciprocal phase shifter”, Y. Okamura et al., Optical and Quantum Electronics 17 (1985) 195-199].

The NALM further includes an output optical path 351. An output path mirror 350 is provided in the output optical path 351 and a splitting coupler 372 optically couples the output optical path 351 to the loop optical path 324. The path mirror 350 has a reflectivity profile selected to reflect the main light pulses back towards the loop optical path 324. The splitting coupler 372 is configured to extract light travelling around the loop optical path 324 to the output optical path 351, and to split light reflected by the NALM mirror 350 into the clockwise and clockwise directions in the loop optical path 324. The splitting coupler 372 may for example be embodied by a 2-by-2 fiber coupler with resonant core coupling, bulk optics couplers with microlenses and beam splitters, or the like. The splitting coupler 372 may for example be a 50/50 coupler, although it will be readily understood that in other embodiments a coupler dividing light according to other proportions may be used. More examples of this oscillator type are provided in US2013230071A1.

Light pulses in the illustrated NALM configuration of FIG. 14 are generated as follows. The loop optical path 324 forms a mirror. Depending on the intensity of the light incident on this mirror, its reflection will vary. Its reflection consists of the interference between the signal propagating in the clockwise direction and that in the counterclockwise direction. Since their nonlinear phases accumulated in the loop will be different (the counterclockwise one is amplified at the beginning of the loop, while the clockwise one is amplified at the end of the loop), the phase difference when they recombine back at the 50/50 coupler may lead to constructive or destructive interference, depending on power. When properly adjusted, this system acts as a saturable absorber, favoring high power at the expense of low power, leading to laser mode-locking of the main light pulses 362. Note that the left-hand part can include another gain fiber to generate more energetic pulses.

The illustrated light pulse generator 320 of FIG. 14 includes a pulse-recycling filter 340 configured to recycle a portion of the counterclockwise pulse in the loop optical path 324. The pulse-recycling filter 340 is provided in a recycling optical path 341, for example a segment of optical fiber, optically coupled to the loop optical path 324 through a recycling coupler 353. In the illustrated embodiment, the recycling coupler 353 is a WDM coupler configured to extract a spectral portion of the cavity light pulses which includes the third wavelength into the recycling optical path 341. The pulse-recycling filter 340 may be embodied by a chirped FBG, as defined above. The pulse-recycling filter 340 has a reflectivity profile centered on a recycling wavelength λ₃ and is configured to reflect a recycled light pulse 364 for a pass through the gain region 330 and extraction through 50/50 coupler 372 to the light output path 351. In some embodiments, the output path mirror 350 may have a spectrally-selective reflectivity profile configured to separate the recycled light pulses from the main light pulses, therefore serving as a light output. In such variants, the output path mirror may for example be embodied by a dichroic filter based on a succession of thin film layers. In other variants, a light output may be coupled to another location along the output optical path 351, and an output pulse separator based on spectral, timing or polarization considerations may be provided to separate the recycled light pulses from the main light pulses.

### Example of Implementation

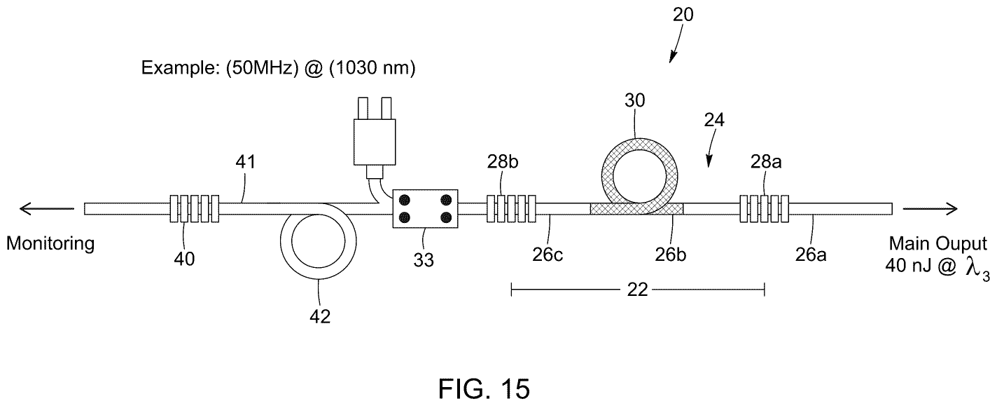

Referring to FIG. 15, there is shown a simulated example of a light pulse generator 20 according to one implementation, for generating output pulses at an output wavelength of 1030 nm and a repetition rate of 50 MHz. The basic configuration of this light pulse generator is similar to the variant of FIG. 1A. Such a light pulse oscillator 20 may for example be adapted for use as a seed light source for a CPA system.

The illustrated light pulse oscillator includes a resonator cavity 22 comprising a cavity optical path 24 apt to induce a spectral broadening of light propagating therealong. The cavity optical path 24 is composed first and second segments of PM optical fiber 26a, 26c respectively hosting cavity-end FBGs 28a, 28b photoinduced therein. A gain region 30, embodied by a length of Yb-doped optical fiber 26b, is provided between the first and second segments of optical fiber 26a, 26b of the cavity optical path 24. The first optical fiber segment 26a, Yb-doped optical fiber 26b and second segment of optical fiber 26b are fused, pigtailed or otherwise coupled to each other. The length of the resonator cavity 22 between the first and second cavity-end FBGs is about 2 m while the second segment of optical fiber 26b embodying the gain medium has a length of about 1 m.

In the illustrated example, the first cavity-end FBG 28a has a reflectivity profile centered on a first wavelength λ₁ of 1045 nm, has a FWHM of 2 nm, a null Group Velocity Dispersion (GVD) and a 60% reflectivity ratio. The second cavity-end FBG 28a has a reflectivity profile centered on a second wavelength λ₂ of 1050 nm, has a FWHM of 2 nm, a null GVD and a 20% reflectivity ratio. And a second wavelength λ₂.

The light pulse generator 20 of the example of FIG. 15 further includes a pulse-recycling filter 40 embodied by a chirped FBG photoinduced in a segment of PM optical fiber embodying a recycling optical path 41. The segment of PM optical fiber hosting the pulse-recycling filter 40 has a length selected to provide a delay line 42 and additional spectral broadening. The pulse-recycling filter 40 has a reflectivity profile centered on a third wavelength λ₃ of 1030 nm. The pulse-recycling filter 40 has a FWHM of 8 nm, a GVD of +10 ps and a 100% reflectivity ratio.

In this variant, the gain region 30 is forward pumped by a laser diode at 976 nm coupled to the recycling path 41 through a WDM coupler 33. The length of the recycling optical path 41 between the second cavity-end filter 28b and the recycling filter 40 is of about 3 to 5 m.

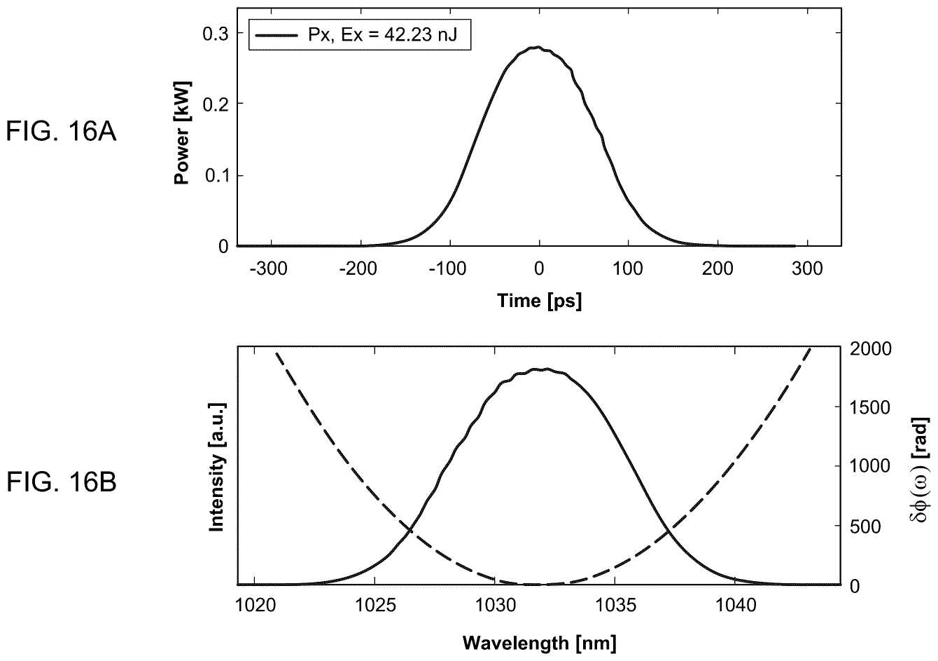

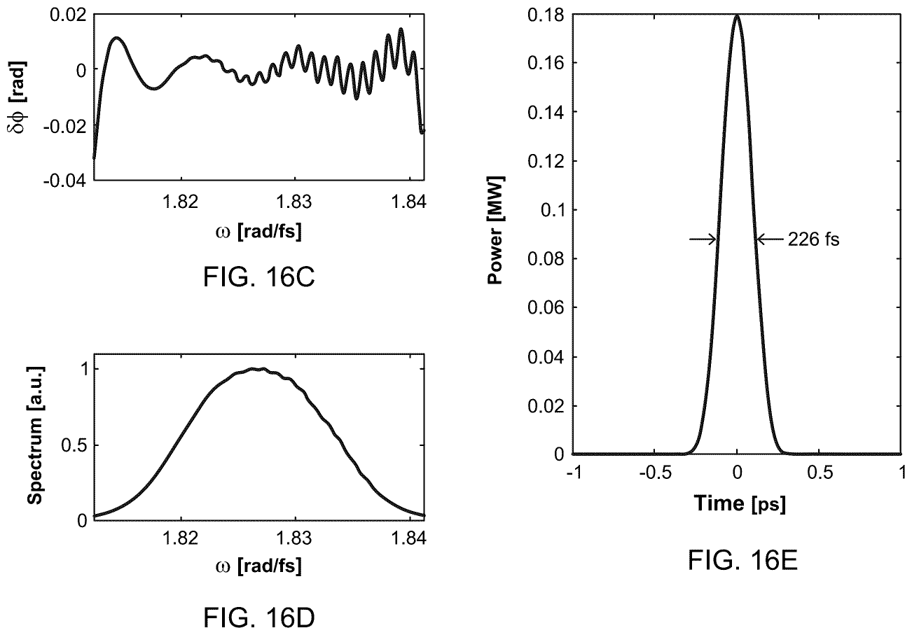

FIG. 16A shows the simulated stretched pulse profile coming from the pulse-recycling filter at the main output. The pulse is highly stretched due to the pulse-recycling filter dispersion. It has high energy (tens of nJ) relative to typical seed sources (less then 1 nJ or even pJ). FIG. 16B shows spectrum and spectral phase for the same pulse. It has a very nice gaussian-like spectral shape, smooth phase and the desired bandwidth. These were shaped to specifications by the pulse-recycling filter. The pulse avoided all spectral and phase distortions from nonlinear effects. This can be seen on FIG. 16C were the relative phase fluctuations after simulated compression by a grating pair are very small. The associated spectrum in function of frequency is also shown below on FIG. 16D. The phase correction and gaussian-like spectrum shaped by the pulse-recycling filter allow for a perfect sub-300 fs gaussian-like pulse profile with great contrast and no sidelobes after compression (see FIG. 16E). These properties are highly desirable for CPA-based femtosecond laser source applications.

### Advantages and Additional Variants

Some implementations of the light pulse generators discussed above and equivalents thereof may provide some advantages over the prior art, such as:
Simplicity. Enables obtaining a pulse with targeted temporal and spectral characteristics for a specific application (e.g. to serve as a seed for CPA systems), without necessarily introducing a circulator at the main output of the fiber oscillator.
Efficiency. Leads to significantly improved laser system efficiency, since the recycled pulses use a significant portion of the energy available in the gain medium. This portion could otherwise be lost in amplified spontaneous emission (ASE) in the absence of recycling. Laser efficiency is therefore increased, and it is possible that the reduction in ASE also reduces the noise level.
Easy start-up and stability without compromising performance. The choice of cavity-end filters at λ₁ and λ₂ in the oscillator can be made to facilitate its start-up without compromising too much the performance of the output pulse, which is in fact the recycled pulse in several examples of implementation. The latter will be able to possess high energy and a spectrum of controlled width within the limits imposed by the width of the gain region and non-overlap with the spectral bands of the filters at λ₁ and λ₂. The only coupling between the recycled pulse and the main oscillator pulse is via gain saturation. It turns out that this interaction leads to a self-stabilizing effect in the system.

One skilled in the art will readily understand that several modifications could be made to the configurations described above for other uses and applications, such as, for example, the production of recycled pulse pairs by adding one more pulse-recycling filter; the production of pulse bursts by adding several pulse-recycling filters; nonlinear conversion using various effects (Raman, four-wave mixing, resonant dispersive waves, etc.) by adjusting the wavelength, stretch and reflectivity profile of the pulse-recycling filter and combining it with a highly nonlinear fiber; the generation of wavelength-tunable pulses using a FBG tunable by mechanical or thermal stretching as the pulse-recycling filter; and the generation of narrow-spectrum picosecond recycled pulses using a narrow-band FBG as the pulse-recycling filter.

Of course, numerous additional modifications could be made to the embodiments described above without departing from the scope of protection as defined in the appended claims.

In some aspects, embodiments of the present invention as described herein include the following items:
1A. A light pulse generator, comprising:
   a linear resonator cavity supporting the back-and-forth propagation of cavity light pulses therein and comprising a linear optical path apt to induce a spectral broadening of the cavity light pulses;
   first and second cavity-end filters disposed at opposite extremities of the linear optical path and delimiting the resonator cavity, the first and second cavity-end filters having corresponding reflectivity profiles respectively centered on a first wavelength and a second wavelength;
   at least one optical gain region positioned in the linear optical path between the cavity-end filters;
   a light output optically coupled to the first cavity-end filter; and
   a pulse-recycling filter optically coupled to the second cavity-end filter and having a reflectivity profile centered on a third wavelength, the pulse-recycling filter configured to receive at least a spectral portion of the cavity light pulses and reflect recycled light pulses for a single pass through the at least one optical gain region and for extraction through the light output.
2A. The light pulse generator according to item 1A, wherein the linear optical path consists of a length of optical fiber comprising one or more optical fiber segments.
3A. The light pulse generator according to item 1A, wherein the linear optical path consists of a length of optical fiber comprising one or more polarization-maintaining optical fiber segments.
4A. The light pulse generator according to item 1A, wherein each optical gain region comprises an optical fiber segment having an active core.
5A. The light pulse generator according to item 1A, wherein the first and second cavity-end filters are Fiber Bragg gratings.
6A. The light pulse generator according to item 1A, wherein the pulse-recycling filter is a Chirped Fiber Bragg grating.
7A. The light pulse generator according to item 6A, further comprising a tuning mechanism for tuning a group delay dispersion profile of the Chirped Fiber Bragg grating.
8A. The light pulse generator according to item 1A, wherein the pulse-recycling filter has a group velocity dispersion selected to prevent an overlap of spectral contents of said recycled light pulses with the reflectivity profile of the first and second cavity-end filters.
9A. The light pulse generator according to item 1A, wherein the pulse recycling filter is outside of the linear resonator cavity.
10A. The light pulse generator according to item 9A, wherein the light pulse generator comprising a recycling optical path optically coupling the pulse-recycling filter and the second cavity-end filter.
11A. The light pulse generator according to item 10A, further comprising a time delay line provided in the recycling optical path.
12A. The light pulse generator according to item 1A, wherein the pulse-recycling filter is optically coupled to linear optical path inside the linear resonator cavity between the second cavity-end filter and the at least one optical gain region.
13A. The light pulse generator according to item 1A, further comprising one or more output pulse separator optically coupled to the light output and configured to select the recycled pulses as output pulses for extraction.
14A. The light pulse generator according to item 13A, wherein the one or more pulse separator comprises a stop band filter configured to suppress light from the cavity light pulses while allowing the recycled light pulses through.
15A. The light pulse generator according to item 14A, wherein the stop band filter comprises a slanted Bragg grating, a dichroic filter and/or WDM coupler filter.
16A. The light pulse generator according to item 13A, wherein the one or more pulse separator comprises a pulse picker configured to perform a time-based separation of the recycled light pulses from the cavity light pulses.
17A. The light pulse generator according to item 16A, wherein the pulse picker comprises an acousto-optic modulator or an electro-optic modulator.
18A. The light pulse generator according to item 13A, wherein the optical path consists of one or more polarization maintaining optical fiber segments, said light pulse generator comprising:
   a recycling optical path optically coupling the pulse-recycling filter and the linear optical path; and
   a polarization rotator provided in the recycling optical path and configured to rotate a polarization state of the recycled light pulses to be orthogonal to a polarization of the cavity light pulses; and
   wherein the one or more output pulse separator further comprises a polarization beamsplitter directing the polarization state associated with the recycled light pulses to the light output.
19A. A light pulse generator, comprising:
   a linear resonator cavity supporting the back-and-forth propagation of cavity light pulses therein and comprising a linear optical path comprising one or more optical fiber segments apt to induce a spectral broadening of the cavity light pulses;
   first and second cavity-end Fiber Bragg gratings (FBGs) disposed at opposite extremities of the linear optical path and delimiting the linear resonator cavity, the first and second cavity-end FBGs having corresponding reflectivity profiles respectively centered on a first wavelength and a second wavelength;
   at least one optical gain region positioned in the linear optical path between the cavity-end FBGs;
   a light output optically coupled to the first cavity-end FBG outside of the linear resonator cavity; and
   a pulse-recycling filter optically coupled to the second outside of the linear resonator cavity and comprising a Chirped Fiber Bragg grating having a reflectivity profile centered on a third wavelength,
   wherein the pulse-recycling filter receives a transmitted spectral portion of the cavity light pulses transmitted through the second cavity-end FBG, reflects a recycled light pulse according to the reflectivity profile centered on a third wavelength, the recycled light pulse entering the linear resonator cavity though the second cavity-end FBG, traversing the linear resonator cavity for a single pass through the at least one optical gain region and exiting the linear resonator cavity through the first cavity-end FBG for extraction through the light output.
20A. The light pulse generator according to item 19A, further comprising a tuning mechanism for tuning a group delay dispersion profile of the Chirped Fiber Bragg grating.
21A. The light pulse generator according to item 19A, wherein the Chirped Fiber Bragg grating has a group velocity dispersion selected to prevent an overlap of spectral contents of said recycled light pulses with the reflectivity profile of the first and second cavity-end filters.
22A. The light pulse generator according to item 19A, further comprising a recycling optical path comprising one or more optical fiber segments coupling the pulse-recycling filter and the second cavity FBG.
23A. The light pulse generator according to item 20A, further comprising:
   a delay line provided in the recycling optical path and having a length selected to temporally separate the recycled light pulses from the cavity light pulses; and
   a pulse picker provided between the first cavity-end FBG and the light output and configured to perform a time-based separation of the recycled light pulses from the cavity light pulses.
24A. The light pulse generator according to item 20A, comprising:
   a polarization rotator provided in the recycling optical path and configured to rotate a polarization state of the recycled light pulses to be orthogonal to a polarization of the cavity light pulses; and
   a polarization beamsplitter optically coupled to the light output and configured to select the recycled pulses as output pulses for extraction based on the polarization state thereof.
25A. The light pulse generator according to item 18A, comprising a stop band filter optically coupled to the light output and configured to spectrally suppress light from the cavity light pulses while allowing the recycled light pulses through.
26A. A light pulse generator, comprising:
   a linear resonator cavity supporting the back-and-forth propagation of cavity light pulses therein and comprising a linear optical path comprising one or more optical fiber segments apt to induce a spectral broadening of the cavity light pulses;
   first and second cavity-end Fiber Bragg Gratings (FBGs) disposed at opposite extremities of the linear optical path and delimiting the resonator cavity, the first and second cavity-end FBGs having reflectivity profiles respectively centered on a first wavelength and a second wavelength;
   at least one optical gain region positioned across the linear optical path between the cavity-end FBGs;
   a light output optically coupled to the first cavity-end FBG outside of the linear resonator cavity; and
   a pulse-recycling filter optically coupled to linear optical path inside the linear resonator cavity between the second cavity-end FBG and the at least one optical gain region and comprising a Chirped Fiber Bragg grating having a reflectivity profile centered on a third wavelength,
   wherein the pulse-recycling filter receives the cavity light pulses propagating towards the second cavity-end FBG and reflects a recycled light pulse according to the reflectivity profile centered on a third wavelength towards to first cavity-end FBG, the recycled light pulse traversing the at least one gain region for a single pass and exiting the linear resonator cavity through the first cavity-end FBG for extraction through the output.
27A. The light pulse generator according to item 26A, further comprising a tuning mechanism for tuning a group delay dispersion profile of the Chirped Fiber Bragg grating.
28A. The light pulse generator according to item 26A, wherein the Chirped Fiber Bragg grating has a group velocity dispersion selected to prevent an overlap of spectral contents of said recycled light pulses with the reflectivity profile of the first and second cavity-end filters.
29A. The light pulse generator according to item 26A, wherein the pulse recycling filter is positioned along the linear optical path at a position selected to temporally separate the recycled light pulses from the cavity light pulses, the light pulse generator further comprising a pulse picker provided between the first cavity-end FBG and the light output and configured to perform a time-based separation of the recycled light pulses from the cavity light pulses.
30A. The light pulse generator according to item 26A, comprising a stop band filter optically coupled to the light output and configured to spectrally suppress light from the cavity light pulses while allowing the recycled light pulses through.
1B. A light pulse generator for generating output light pulses, comprising:
   a resonator cavity in a Mamyshev oscillator configuration defined by a first and a second spectrally-selective filters and a spectrally broadening optical path, the first and second spectrally-selective filters having respective selection spectral profiles offset from each other, the resonator cavity supporting the resonant propagation of cavity light pulses;
   an optical gain region positioned within the resonator cavity and amplifying light passing therethrough;
   a pulse-recycling filter having a reflectivity profile centered on a recycling wavelength outside of the respective selection spectral profiles of the first and second spectrally-selective filters, the pulse-recycling filter being optically coupled to the resonator cavity such that the cavity light pulses are incident thereon after being spectrally broadened to encompass said recycling wavelength, the pulse-recycling filter reflecting recycled light pulses according to said reflectivity profile centered on the recycling wavelength, the recycled light pulses propagating in the resonator cavity for a single pass through the optical gain region; and
   a light output optically coupled to the resonator cavity and configured to extract the output pulses therefrom, said output light pulses containing at least said recycled light pulses.
2B. The light pulse generator according to item 1B, wherein the spectrally broadening optical path consists of a length of optical fiber comprising one or more optical fiber segments.
3B. The light pulse generator according to item 2B, wherein at least one of said one or more optical fiber segments is polarization-maintaining.
4B. The light pulse generator according to item 1B, wherein the optical gain region comprises an optical fiber segment having an active core.
5B. The light pulse generator according to any one of items 1B to 4B, comprising one or more additional optical gain regions.
6B. The light pulse generator according to any one of items 1B to 4B, wherein the pulse-recycling filter is a Chirped Fiber Bragg grating.
7B. The light pulse generator according to item 6B, further comprising a tuning mechanism for tuning a group velocity dispersion profile of the Chirped Fiber Bragg grating.
8B. The light pulse generator according to any one of items 1B to 7B, wherein the pulse-recycling filter has a group velocity dispersion selected to prevent an overlap of spectral contents of said recycled light pulses with the reflectivity profile of the first and second cavity-end filter.
9B. The light pulse generator according to any one of items 1B to 8B, further comprising an output pulse separator optically coupled to the light output and configured to select the recycled pulses as said output pulses for extraction.
10B. The light pulse generator according to item 9B, wherein the output pulse separator is configured to select the recycled pulses based on timing.
11B. The light pulse generator according to item 9B, wherein the output pulse separator is configured to select the recycled pulses based on wavelength.
12B. The light pulse generator according to item 9B, wherein the output pulse separator is configured to select the recycled pulses based on polarization.
13B. The light pulse generator according to any one of items 1B to 8B, wherein the resonator cavity is a linear resonator cavity, and the first and second spectrally-selective filters are reflective filters reflecting the cavity light pulses back-and-forth therebetween.
14B. The light pulse generator according to item 13B, wherein the pulse recycling filter is outside of the linear resonator cavity.
15B. The light pulse generator according to item 14B, wherein the light pulse generator comprises a recycling optical path optically coupling the pulse-recycling filter and the second spectrally-selective filter.
16B. The light pulse generator according to item 14B, wherein the pulse-recycling filter is optically coupled to the spectrally broadening optical path inside the linear resonator cavity between the second spectrally-selective filter and the optical gain region.
17B. The light pulse generator according to item 14B, further comprising an output pulse separator optically coupled to the light output and configured to select the recycled pulses as said output pulses for extraction.
18B. The light pulse generator according to item 17B, wherein the output pulse separator comprises a stop band filter configured to suppress the cavity light pulses while allowing the recycled light pulses through.
19B. The light pulse generator according to item 17B, wherein the output pulse separator comprises a pulse picker configured to perform a time-based separation of the recycled light pulses from the cavity light pulses.
20B. The light pulse generator according to item 17B, wherein the optical path consists of one or more polarization maintaining optical fiber segments, said light pulse generator comprising:
   a recycling optical path optically coupling the pulse-recycling filter and the spectrally broadening optical path; and
   a polarization rotator provided in the recycling optical path and configured to rotate a polarization state of the recycled light pulses to be orthogonal to a polarization of the cavity light pulses; and
   wherein the output pulse separator further comprises a polarization beamsplitter directing the polarization state associated with the recycled light pulses to the light output.
21B. The light pulse generator according to any one of items 1B to 8B, wherein the resonator cavity is a ring resonator cavity, and the first and second spectrally-selective filters are transmissive filters propagating the cavity light pulses around the ring resonator cavity along a cavity propagation direction.
22B. The light pulse generator according to item 21B, wherein the pulse-recycling filter extends in the spectrally broadening optical path of the ring resonator cavity.
23B. The light pulse generator according to item 21B, further comprising a recycling optical path hosting the pulse-recycling filter and a recycling WDM coupler coupling the recycling optical path to the spectrally broadening optical path of the ring resonator cavity.
24B. The light pulse generator according to any one of items 21B to 23B, further comprising an output pulse separator configured to direct the recycled light pulses to the light output while allowing the cavity light pulses to continue propagating around the ring resonator cavity along the cavity propagation direction.
25B. The light pulse generator according to item 24B, wherein the output pulse separator comprises a spectrally sensitive output coupler having a spectrally selective profile configured to extract the recycling light pulses to the light output.
26B. The light pulse generator according to item 24B, wherein the output pulse separator comprises an output WDM coupler provided in a path of the recycle light pulses and configured to extract the recycled light pulses to an output optical fiber segment optically coupled to the light output.
27B. The light pulse generator according to item 24B, wherein the optical path consists of one or more polarization maintaining optical fiber segments, and wherein the output pulse separator comprises:
   a polarization rotator provided between the pulse-recycling filter and the optical gain region and configured to rotate a polarization state of the recycled light pulses to be orthogonal to a polarization of the cavity light pulses; and
   a polarization beamsplitter directing the polarization state associated with the recycled light pulses to the light output.
1C. A light pulse generator for generating output light pulses, comprising:
   a resonator cavity comprising a cavity optical path apt to induce a spectral broadening of cavity light pulses propagating within said cavity;
   first and second cavity-end filters disposed at opposite extremities of the optical path and each having a corresponding reflective spectral band, the reflective spectral bands of the cavity-end filters substantially overlapping, thereby defining an overlap spectral range;
   an optical gain region positioned in the cavity optical path between the cavity-end filters;
   a blocking filter positioned in the cavity optical path between the cavity-end filters and configured to remove light at wavelengths within a blocking spectral range from the cavity optical path, the blocking spectral range including at least the overlap spectral range;
   a pulse-recycling filter optically coupled to the cavity optical path such that the cavity light pulses are incident thereon, the pulse-recycling filter having a reflectivity profile non-overlapping with the reflective spectral bands of the first and second cavity-end filters and centered on a recycling wavelength, the pulse-recycling filter being configured to reflect recycled light pulses according to said reflectivity profile thereof for a single pass through the optical gain region; and
   a light output optically coupled to the cavity optical path and configured to extract the output light pulses therefrom, said output light pulses containing at least said recycled light pulses.
2C. The light pulse generator according to item 1C, wherein the linear optical path consists of a length of optical fiber comprising one or more optical fiber segments.
3C. The light pulse generator according to item 2C, wherein at least one of said one or more optical fiber segments is polarization-maintaining.
4C. The light pulse generator according to item 1C, wherein the optical gain region comprises an optical fiber segment having an active core.
5C. The light pulse generator according to any one of items 1C to 4C, further comprising an additional gain region, the blocking filter being positioned between the optical gain region and the additional gain region.
6C. The light pulse generator according to any one of items 1C to 4C, wherein the first and second cavity-end filters are Fiber Bragg gratings.
7C. The light pulse generator according to any one of items 1C to 6C, wherein the wherein the blocking filter is a slanted Fiber Bragg Grating or a Long Period Grating.
8C. The light pulse generator according to any one of items 1C to 7C, wherein the overlap spectral range is at least about 10%, preferably at least 30% and further preferably at least 80% of the reflective spectral band of the spectrally selective filters.
9C. The light pulse generator according to any one of items 1C to 8C, wherein the pulse-recycling filter is a Chirped Fiber Bragg grating.
10C. The light pulse generator according to item 9C, wherein the pulse-recycling filter has a group velocity dispersion selected to prevent an overlap of spectral contents of said recycled light pulses with the reflectivity band of the first and second cavity-end filters.
11C. The light pulse generator according to any one of items 1C to 10C, wherein the pulse recycling filter is outside of the linear resonator cavity, the light pulse generator comprising a recycling optical path optically coupling the pulse-recycling filter and the second cavity-end filter.
12C. The light pulse generator according to any one of items 1C to 10C, wherein the pulse-recycling filter is optically coupled to linear optical path inside the linear resonator cavity between the second cavity-end filter and the at least one optical gain region.
13C. The light pulse generator according to any one of items 1C to 12C, further comprising an output pulse separator optically coupled to the light output and configured to select the recycled pulses as output pulses for extraction, the output pulse separator using a spectral-based separation mechanism.
14C. The light pulse generator according to any one of items 1C to 13C, further comprising an output pulse separator optically coupled to the light output and configured to select the recycled pulses as output pulses for extraction, wherein the output pulse separator uses a time-based separation mechanism.
15C. The light pulse generator according to any one of items 1C to 14C, further comprising an output pulse separator optically coupled to the light output and configured to select the recycled pulses as output pulses for extraction, wherein the output pulse separator uses a polarization-based separation mechanism.
1D. A light pulse generator, comprising:
   a ring resonator cavity supporting the propagation of cavity light pulses therearound along a cavity propagation direction, the ring resonator cavity comprising a ring-shaped optical path apt to induce a spectral broadening of the cavity light pulses;
   first and second transmissive filters disposed in the ring-shaped optical path, the first and second transmissive filters having corresponding transmission profiles in the cavity propagation direction respectively centered on a first wavelength and a second wavelength;
   a pulse-recycling filter optically coupled to the ring-shaped optical cavity and having a reflectivity profile centered on a third wavelength, the pulse-recycling filter configured to reflect a recycled light pulse in the ring resonator cavity along a counterpropagation direction opposite the cavity propagation direction;
   an output optically connected to the ring-shaped optical path for extraction of light circulating in the counterpropagating direction; and
   an optical gain region positioned in the ring-shaped optical path between the pulse-recycling filter and the output along the counterpropagating direction, whereby the recycled optical pulses are extracted from the ring resonator cavity after a single pass through said optical gain region.
2D. The light pulse generator according to item 1D, wherein the ring-shaped optical path consists of a length of optical fiber comprising one or more optical fiber segments.
3D. The light pulse generator according to item 2D, wherein at least one of said one or more optical fiber segment is polarization-maintaining.
4D. The light pulse generator according to item 1D, wherein the optical gain region comprises an optical fiber segment having an active core.
5D. The light pulse generator according to any one of items 1D to 4D, comprising one or more additional gain regions.
6D. The light pulse generator according to any one of items 1D to 5D, wherein the first and second transmissive filters each comprise a Fiber Bragg Grating coupled to the ring-shaped optical path with a circulator or one or more slanted Fiber Bragg Gratings used in transmission.
7D. The light pulse generator according to any one of items 1D to 6D, wherein the pulse-recycling filter is a Chirped Fiber Bragg Grating.
8D. The light pulse generator according to any one of items 1D to 7D, wherein the pulse-recycling filter extends in the ring-shaped optical path of the ring resonator cavity.
9D. The light pulse generator according to any one of items 1D to 7D, further comprising a recycling optical path hosting the pulse-recycling filter and a recycling coupler coupling the recycling optical path to the ring-shaped optical path of the ring resonator cavity.
10D. The light pulse generator according to any one of items 1D to 9D, further comprising an output pulse separator configured to direct the recycled light pulses to the light output while allowing the cavity light pulses to continue propagating around the ring resonator cavity.
11D. The light pulse generator according to item 10D, wherein the output pulse separator comprises a spectrally sensitive output coupler having a spectrally selective profile configured to extract the recycled light pulses to the light output.
12D. The light pulse generator according to item 10D, wherein the output pulse separator comprises an output WDM coupler provided in a path of the recycle light pulses and configured to extract the recycled light pulses to an output optical fiber segment optically coupled to the light output.
13D. The light pulse generator according to item 10D, wherein the optical path consists of one or more polarization maintaining optical fiber segments, and wherein the output pulse separator comprises:
   a polarization rotator provided between the pulse-recycling filter and the optical gain region and configured to rotate a polarization state of the recycled light pulses to be orthogonal to a polarization of the cavity light pulses; and
   a polarization beamsplitter directing light in the polarization state associated with the recycled light pulses to the light output.
1E. A light pulse generator for generating output light pulses, comprising:
   a Nonlinear Amplifying Loop Mirror comprising:
      a loop optical path supporting the propagation of main light pulses therearound in a clockwise direction and counterclockwise direction;
      at least one optical gain region positioned within the loop optical path;
      a non-reciprocal phase shifter positioned within the loop optical path;
      an output optical path;
      an output path mirror provided in the output optical path and reflecting the main light pulses; and
      a splitting coupler optically coupling the output optical path to the loop optical path, the splitting coupler configured to extract light travelling around the loop optical path to the output optical path, and to split the main light pulses reflected by the output path mirror into the clockwise and clockwise directions in the loop optical path;
   a pulse-recycling filter optically coupled to the loop optical path such that the main light pulses are incident thereon, the pulse-recycling filter having a reflectivity profile centered on a recycling wavelength and being configured to reflect a recycled light pulse to the loop optical path for a single pass through the gain region and extraction through the splitting coupler to the output optical path;
   wherein the recycled pulses are extracted from the output optical path as said output light pulses.
2E. The light pulse generator according to item 1E, wherein the loop optical path consists of a length of optical fiber comprising one or more optical fiber segments.
3E. The light pulse generator according to item 2E, wherein at least one of said one or more optical fiber segment is polarization-maintaining.
4E. The light pulse generator according to item 1E, wherein the optical gain region comprises an optical fiber segment having an active core.
5E. The light pulse generator according to any one of items 1E to 4E, wherein the splitting coupler is a 50/50 coupler.
6E. The light pulse generator according to any one of items 1E to 4E, wherein non-reciprocal phase shifter comprises a polarization rotator.
7E. The light pulse generator according to any one of items 1E to 6E, comprising one or more additional gain regions.
8E. The light pulse generator according to any one of items 1E to 7E, wherein the pulse-recycling filter is a Chirped Fiber Bragg Grating.
9E. The light pulse generator according to any one of items 1E to 8E, further comprising a recycling optical path hosting the pulse-recycling filter and a recycling coupler coupling the recycling optical path to the loop optical path.
10E. The light pulse generator according to any one of items 1E to 9E, wherein the output path mirror has a spectrally-selective reflectivity profile configured to separate the recycled light pulses from the main light pulses.
11E. The light pulse generator according to any one of items 1E to 10E, further comprising an output pulse separator optically coupled to the output optical path and configured to select the recycled pulses as output pulses for extraction.
1F. A light pulse generator for generating output light pulses, comprising:
   a resonator cavity configured to support cavity light pulses for resonant propagation therein and to induce a spectral broadening of the cavity light pulses propagating within said cavity;
   an optical gain region positioned in the resonator cavity;
   a first spectrally-selective filter having a spectral profile centered on a first wavelength and a second spectrally-selective filter having a spectral profile centered on a second wavelength, the first and second optical filters being positioned in the resonator cavity to reflect or transmit spectral portions of the cavity light pulses within the corresponding spectral profile towards the optical gain region;
   a pulse-recycling filter optically coupled to the resonator cavity such that the cavity light pulses are incident thereon, the pulse-recycling filter having a reflectivity profile non-overlapping with the spectral profiles of the first and second spectrally-selective filters and centered on a third wavelength, the pulse-recycling filter being configured to reflect a recycled light pulse at said third wavelength circulating through the gain region for a single pass; and
   an output optically configured to extract the output pulses from the resonator cavity, said output light pulses containing at least light at said third wavelength.

1. A light pulse generator, comprising:
a linear resonator cavity supporting the back-and-forth propagation of cavity light pulses therein and comprising a linear optical path apt to induce a spectral broadening of the cavity light pulses;
first and second cavity-end filters disposed at opposite extremities of the linear optical path and delimiting the resonator cavity, the first and second cavity-end filters having corresponding reflectivity profiles respectively centered on a first wavelength and a second wavelength;
at least one optical gain region positioned in the linear optical path between the cavity-end filters;
a light output optically coupled to the first cavity-end filter; and
a pulse-recycling filter optically coupled to the second cavity-end filter and having a reflectivity profile centered on a third wavelength, the pulse-recycling filter configured to receive at least a spectral portion of the cavity light pulses and reflect recycled light pulses for a single pass through the at least one optical gain region and for extraction through the light output.

2. The light pulse generator according to claim 1, wherein the linear optical path consists of a length of optical fiber comprising one or more optical fiber segments.

3. The light pulse generator according to claim 1, wherein the linear optical path consists of a length of optical fiber comprising one or more polarization-maintaining optical fiber segments.

4. The light pulse generator according to claim 1, wherein each optical gain region comprises an optical fiber segment having an active core.

5. The light pulse generator according to claim 1, wherein the first and second cavity-end filters are Fiber Bragg gratings.

6. The light pulse generator according to claim 1, wherein the pulse-recycling filter is a Chirped Fiber Bragg grating.

7. The light pulse generator according to claim 6, further comprising a tuning mechanism for tuning a group delay dispersion profile of the Chirped Fiber Bragg grating.

8. The light pulse generator according to claim 1, wherein the pulse-recycling filter has a group velocity dispersion selected to prevent an overlap of spectral contents of said recycled light pulses with the reflectivity profile of the first and second cavity-end filters.

9. The light pulse generator according to claim 1, wherein the pulse recycling filter is outside of the linear resonator cavity.

10. The light pulse generator according to claim 9, wherein the light pulse generator comprising a recycling optical path optically coupling the pulse-recycling filter and the second cavity-end filter.

11. The light pulse generator according to claim 10, further comprising a time delay line provided in the recycling optical path.

12. The light pulse generator according to claim 1, wherein the pulse-recycling filter is optically coupled to linear optical path inside the linear resonator cavity between the second cavity-end filter and the at least one optical gain region.

13. The light pulse generator according to claim 1, further comprising one or more output pulse separator optically coupled to the light output and configured to select the recycled pulses as output pulses for extraction.

14. The light pulse generator according to claim 13, wherein the one or more pulse separator comprises a stop band filter configured to suppress light from the cavity light pulses while allowing the recycled light pulses through.

15. The light pulse generator according to claim 14, wherein the stop band filter comprises a slanted Bragg grating, a dichroic filter and/or WDM coupler filter.

16. The light pulse generator according to claim 13, wherein the one or more pulse separator comprises a pulse picker configured to perform a time-based separation of the recycled light pulses from the cavity light pulses.

17. The light pulse generator according to claim 16, wherein the pulse picker comprises an acousto-optic modulator or an electro-optic modulator.

18. The light pulse generator according to claim 13, wherein the optical path consists of one or more polarization maintaining optical fiber segments, said light pulse generator comprising:
a recycling optical path optically coupling the pulse-recycling filter and the linear optical path; and
a polarization rotator provided in the recycling optical path and configured to rotate a polarization state of the recycled light pulses to be orthogonal to a polarization of the cavity light pulses; and
wherein the one or more output pulse separator further comprises a polarization beamsplitter directing the polarization state associated with the recycled light pulses to the light output.

19. A light pulse generator, comprising:
a linear resonator cavity supporting the back-and-forth propagation of cavity light pulses therein and comprising a linear optical path comprising one or more optical fiber segments apt to induce a spectral broadening of the cavity light pulses;
first and second cavity-end Fiber Bragg gratings (FBGs) disposed at opposite extremities of the linear optical path and delimiting the linear resonator cavity, the first and second cavity-end FBGs having corresponding reflectivity profiles respectively centered on a first wavelength and a second wavelength;
at least one optical gain region positioned in the linear optical path between the cavity-end FBGs;
a light output optically coupled to the first cavity-end FBG outside of the linear resonator cavity; and
a pulse-recycling filter optically coupled to the second outside of the linear resonator cavity and comprising a Chirped Fiber Bragg grating having a reflectivity profile centered on a third wavelength,
wherein the pulse-recycling filter receives a transmitted spectral portion of the cavity light pulses transmitted through the second cavity-end FBG, reflects a recycled light pulse according to the reflectivity profile centered on a third wavelength, the recycled light pulse entering the linear resonator cavity though the second cavity-end FBG, traversing the linear resonator cavity for a single pass through the at least one optical gain region and exiting the linear resonator cavity through the first cavity-end FBG for extraction through the light output.

20. The light pulse generator according to claim 19, further comprising a tuning mechanism for tuning a group delay dispersion profile of the Chirped Fiber Bragg grating.

21. The light pulse generator according to claim 19, wherein the Chirped Fiber Bragg grating has a group velocity dispersion selected to prevent an overlap of spectral contents of said recycled light pulses with the reflectivity profile of the first and second cavity-end filters.

22. The light pulse generator according to claim 19, further comprising a recycling optical path comprising one or more optical fiber segments coupling the pulse-recycling filter and the second cavity FBG.

23. The light pulse generator according to claim 20, further comprising:
a delay line provided in the recycling optical path and having a length selected to temporally separate the recycled light pulses from the cavity light pulses; and
a pulse picker provided between the first cavity-end FBG and the light output and configured to perform a time-based separation of the recycled light pulses from the cavity light pulses.

24. The light pulse generator according to claim 20, comprising:
a polarization rotator provided in the recycling optical path and configured to rotate a polarization state of the recycled light pulses to be orthogonal to a polarization of the cavity light pulses; and
a polarization beamsplitter optically coupled to the light output and configured to select the recycled pulses as output pulses for extraction based on the polarization state thereof.

25. The light pulse generator according to claim 18, comprising a stop band filter optically coupled to the light output and configured to spectrally suppress light from the cavity light pulses while allowing the recycled light pulses through.

26. A light pulse generator, comprising:
a linear resonator cavity supporting the back-and-forth propagation of cavity light pulses therein and comprising a linear optical path comprising one or more optical fiber segments apt to induce a spectral broadening of the cavity light pulses;
first and second cavity-end Fiber Bragg Gratings (FBGs) disposed at opposite extremities of the linear optical path and delimiting the resonator cavity, the first and second cavity-end FBGs having reflectivity profiles respectively centered on a first wavelength and a second wavelength;
at least one optical gain region positioned across the linear optical path between the cavity-end FBGs;
a light output optically coupled to the first cavity-end FBG outside of the linear resonator cavity; and
a pulse-recycling filter optically coupled to linear optical path inside the linear resonator cavity between the second cavity-end FBG and the at least one optical gain region and comprising a Chirped Fiber Bragg grating having a reflectivity profile centered on a third wavelength,
wherein the pulse-recycling filter receives the cavity light pulses propagating towards the second cavity-end FBG and reflects a recycled light pulse according to the reflectivity profile centered on a third wavelength towards to first cavity-end FBG, the recycled light pulse traversing the at least one gain region for a single pass and exiting the linear resonator cavity through the first cavity-end FBG for extraction through the output.

27. The light pulse generator according to claim 26, further comprising a tuning mechanism for tuning a group delay dispersion profile of the Chirped Fiber Bragg grating.

28. The light pulse generator according to claim 26, wherein the Chirped Fiber Bragg grating has a group velocity dispersion selected to prevent an overlap of spectral contents of said recycled light pulses with the reflectivity profile of the first and second cavity-end filters.

29. The light pulse generator according to claim 26, wherein the pulse recycling filter is positioned along the linear optical path at a position selected to temporally separate the recycled light pulses from the cavity light pulses, the light pulse generator further comprising a pulse picker provided between the first cavity-end FBG and the light output and configured to perform a time-based separation of the recycled light pulses from the cavity light pulses.

30. The light pulse generator according to claim 26, comprising a stop band filter optically coupled to the light output and configured to spectrally suppress light from the cavity light pulses while allowing the recycled light pulses through.
